(19) United States
(12) Patent Application Publication
(10) Pub. No.: US 2016/0091824 A1
(43) Pub. Date: Mar. 31, 2016

(54) DEVELOPER SUPPLY CARTRIDGE

(71) Applicant: CANON KABUSHIKI KAISHA, Tokyo (JP)

(72) Inventors: Takakuni Kobori, Toride-shi (JP); Hiroyuki Fujikawa, Yokohama-shi (JP); Nozomu Komatsu, Toride-shi (JP); Kohji Takenaka, Toride-shi (JP); Hideki Kaneko, Yokohama-shi (JP); Takeshi Hashimoto, Moriya-shi (JP); Yosuke Iwasaki, Abiko-shi (JP); Ichiro Kanno, Abiko-shi (JP); Nobuyuki Yomoda, Kashiwa-shi (JP); Akihito Kamura, Kashiwa-shi (JP); Manabu Jimba, Toride-shi (JP); Ayatomo Okino, Moriya-shi (JP)

(21) Appl. No.: 14/866,230

(22) Filed: Sep. 25, 2015

(30) Foreign Application Priority Data
Sep. 29, 2014 (JP) 2014-199425
Sep. 2, 2015 (JP) 2015-173276

(51) Int. Cl. G03G 15/08

(52) U.S. Cl. CPC G03G 15/0877

(57) ABSTRACT

A developer supply cartridge includes a developer supply container. The developer supply container includes a developer accommodation section, a developer in the developer accommodation section, a discharging port configured to discharge the developer toward a developer supply apparatus, a pump unit configured to perform an exhaust operation through the discharging port, a developer storage section configured to store a certain amount of developer before discharge, the developer storage section communicating with the developer accommodation section and being in contact with the discharging port, and a suppression part configured to control inflow and suppression of inflow of the developer from the developer accommodation section to the developer storage section and suppress the inflow of the developer during the exhaust operation of the pump unit. The developer has a compressibility Ct of 30.0% or more and 45.0% or less.

### BACKGROUND

1. Field

Aspects of the present invention generally relate to a developer supply cartridge detachably attachable to a developer supply apparatus for use in image-forming apparatuses, such as copying machines, facsimile machines, printers, and multifunction apparatuses having these functions.

2. Description of the Related Art

Particulate developers are generally used in electrophotographic image-forming apparatuses, such as copying machines. Upon consumption of a developer by image formation, the developer is supplied from a developer supply cartridge in order for image output.

In order to consistently supply a developing unit with a developer, many existing image-forming apparatuses include a primary storage space for primarily storing the developer supplied from a developer supply cartridge in an image-forming apparatus and supplying the developing unit with a certain amount of the developer.

In recent years, however, as the size and weight of image-forming apparatuses, such as copying machines, have been decreasing, a developer has sometimes been directly supplied from a developer supply cartridge to a developing unit without travelling through such a primary storage space.

Thus, developer supply cartridges should be able to supply a proper amount of developer depending on the required amount of developer that can vary with image formation.

Japanese Patent Laid-Open No. 2010-256894 describes a developer supply container for use in such existing developer supply cartridges.

In an apparatus described in Japanese Patent Laid-Open No. 2010-256894, a developer is discharged using a bellows pump installed in the developer supply container. More specifically, the bellows pump is expanded to decrease the internal pressure of the developer supply container so as to be below the atmospheric pressure, take air into the developer supply container, and thereby fluidize the developer. The bellows pump is then contracted to increase the internal pressure of the developer supply container so as to be above the atmospheric pressure and discharge the developer utilizing a pressure difference between the inside and outside of the developer supply container. These two steps are alternately performed multiple times to prevent clogging of a discharging port of the developer supply cartridge with the developer in the vicinity thereof, decrease the amount of residual developer in the developer supply cartridge, and consistently supply the developer.

However, in recent years, there has been a growing demand for supply of a proper amount of developer.

A developer in a developer supply cartridge may be excessively compressed by tapping of the developer in a container due to vibration during transport and storage. In a discharge control system utilizing variations in internal pressure as described above, a compressed developer may be further compressed and clog a discharging port. On the other hand, a phenomenon called flushing may occur. In flushing, a large amount of developer is discharged at the same time. The flowability of developers depends on the temperature and humidity of the storage environment. In order to achieve stable discharge and high supply accuracy in various environments, matching of a developer supply cartridge and a developer as well as a developer supply container must be enhanced.

### SUMMARY

Aspects of the present invention generally provide a developer supply cartridge that can accurately supply an image-forming apparatus with a developer in various storage and operating environments.

According to an aspect of the present invention, a developer supply cartridge detachably attachable to a developer supply apparatus includes a developer supply container that includes (i) a developer accommodation section configured to contain a developer, (ii) a developer in the developer accommodation section, (iii) a discharging port through which the developer in the developer accommodation section is discharged toward the developer supply apparatus, (iv) a pump unit configured to perform an exhaust operation through the discharging port, (v) a developer storage section configured to store a certain amount of developer before discharge, the developer storage section communicating with the developer accommodation section and being in contact with the discharging port, and (vi) a suppression part configured to control inflow and suppression of inflow of the developer from the developer accommodation section to the developer storage section and suppress the inflow of the developer during the exhaust operation of the pump unit, wherein the developer has a compressibility Ct of 30.0% or more and 45.0% or less.

Aspects of the present invention generally provide a developer supply cartridge that can accurately supply an image-forming apparatus with a developer in various storage and operating environments.

Further features of the present disclosure will become apparent from the following description of exemplary embodiments with reference to the attached drawings.

### BRIEF DESCRIPTION OF THE DRAWINGS

FIG. 1 is a schematic view of a surface treatment apparatus (thermal spheronization treatment apparatus).

FIG. 2 is a cross-sectional view of the entire structure of an image-forming apparatus (copying machine).

FIG. 3A is a fragmentary sectional view of a developing unit, FIG. 3B is a perspective view of a holder, and FIG. 3C is a cross-sectional view of the holder.

FIG. 4A is an enlarged cross-sectional view of a developer supply container and a developer supply apparatus, FIG. 4B is an enlarged cross-sectional view of another developer supply apparatus, and FIG. 4C is a flow chart of a developer supply flow.

FIG. 5A is an overall perspective view of the developer supply container, FIG. 5B is a fragmentary enlarged view of the periphery of a discharging port, and FIG. 5C is a front view of the developer supply container in the holder of the developer supply apparatus.

FIG. 6A is a cross-sectional perspective view of the developer supply container, FIG. 6B is a fragmentary sectional view in which the pump unit is fully expanded, and FIG. 6C is a fragmentary sectional view in which the pump unit is fully contracted.

FIG. 7A is a fragmentary view in which the pump unit is fully expanded, FIG. 7B is a fragmentary view in which the pump unit is fully contracted, and FIG. 7C is a fragmentary view of the pump unit.

FIGS. 8A to 8F are development views of cam grooves.

FIG. 9A is an overall perspective view of a conveying member to be installed in a container described in Example 1, and FIG. 9B is a side view of the conveying member.

FIG. 10A is a cross-sectional view of a discharge section while the pump unit is stopped, FIG. 10B is a cross-sectional view of the discharge section during intake, FIG. 10C is a cross-sectional view of the discharge section during exhaustion, and FIG. 10D is a cross-sectional view of the discharge section after a developer is discharged.

FIG. 11 is a cross-sectional perspective view of an existing developer supply container.

FIG. 12 is a schematic view of another existing developer supply container.

### DESCRIPTION OF THE EMBODIMENTS

A developer supply cartridge according to an embodiment of the present invention is a developer supply cartridge detachably attachable to a developer supply apparatus. The developer supply cartridge includes a developer supply container, which includes

(i) a developer accommodation section,
(ii) a developer in the developer accommodation section, (iii) a discharging port through which the developer in the developer accommodation section is discharged toward the developer supply apparatus,
(iv) a pump unit configured to perform an exhaust operation through the discharging port,
(v) a developer storage section configured to store a certain amount of developer before discharge, the developer storage section communicating with the developer accommodation section and being in contact with the discharging port, and
(vi) a suppression part configured to control inflow and suppression of inflow of the developer from the developer accommodation section to the developer storage section and suppress the inflow of the developer during the exhaust operation of the pump unit,
wherein the developer has a compressibility Ct of 30.0% or more and 45.0% or less.

One of the features of the present invention is that the developer supply container includes a developer storage section having a certain volume and discharges only a developer temporarily stored in the developer storage section, thereby consistently supplying the developer.

A steady inflow of a developer into a developer storage section and reduced variations in the volume of the developer in the developer storage section can be achieved by controlling the compressibility Ct of the developer within a specific range. The compressibility Ct is the ratio of the loose bulk density to the compacted bulk density (tap density). Thus, the amount of developer discharged from the developer supply cartridge can be properly controlled.

The tap density ρₜ of the developer is preferably 0.60 g/cm³ or more and 0.90 g/cm³ or less. When the developer has a tap density in this range, not only can the developer supply cartridge be efficiently utilized, but the operation energy of the developer supply apparatus can also be decreased.

The developer can be a two-component developer containing a carrier and a toner.

The developer (two-component developer) more preferably contains 3.0 parts or more and 30.0 parts or less by mass of the toner per part by mass of the carrier. When the ratio of the carrier to the toner is within this range, the carrier and the toner can be well mixed.

### [Resin]

Examples of a binder resin for use in a toner according to an embodiment of the present invention include, but are not limited to,

homopolymers (styrene-type homopolymers) of styrene and styrene derivatives (substitution products), such as polystyrene, poly-p-chlorostyrene, and polyvinyltoluene; styrene-type copolymers, such as styrene-p-chlorostyrene copolymers, styrene-vinyltoluene copolymers, styrene-vinylnaphthalene copolymers, styrene-acrylate copolymers, styrene-methacrylate copolymers, styrene-a-chloromethyl methacrylate copolymers, styrene-acrylonitrile copolymers, styrene-vinyl methyl ether copolymers, styrene-vinyl ethyl ether copolymers, styrene-vinyl methyl ketone copolymers, and styrene-acrylonitrile-indene copolymers;
poly(vinyl chloride);
phenolic resins;
natural modified phenolic resins;
natural resin modified maleic acid resins;
acrylic resins;
methacrylate resins;
poly(vinyl acetate);
silicone resins;
polyester resins;
polyurethane;
polyamide resins;
furan resins;
epoxy resins;
xylene resins;
poly(vinyl butyral);
terpene resins;
coumarone-indene resins; and
petroleum-type resins.

Among these, polyester resins can provide improved low-temperature fixability and controlled chargeability.

The term “polyester resins”, as used herein, refers to resins having a “polyester unit” in a binder resin chain (resin molecule). Examples of components to constitute (synthesize) the polyester unit, include, but are not limited to,

divalent and polyvalent alcohol monomer components, and acid monomer components, such as divalent and polyvalent carboxylic acids, divalent and polyvalent carboxylic anhydrides, and divalent and polyvalent carboxylate esters.

Examples of the divalent and polyvalent alcohol monomer components include, but are not limited to, alkylene oxide adducts of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane;

ethylene glycol;
diethylene glycol;
triethylene glycol;
1,2-propylene glycol;
1,3-propylene glycol;
1,4-butanediol;
neopentyl glycol;
1,4-butenediol;
1,5-pentanediol;
1,6-hexanediol;
1,4-cyclohexanedimethanol;
dipropylene glycol;
poly(ethylene glycol);
poly(propylene glycol);
poly(tetramethylene glycol);
sorbit (sorbitol);
1,2,3,6-hexanetetrol;
1,4-sorbitan;
pentaerythritol;
dipentaerythritol;
tripentaerythritol;
1,2,4-butanetriol;
1,2,5-pentanetriol;
glycerin;
2-methylpropanetriol;
2-methyl-1,2,4-butanetriol;
trimethylolethane;
trimethylolpropane; and
1,3,5-trihydroxymethylbenzene.

Among these, the alcohol monomer component may be an aromatic diol. An aromatic diol preferably constitutes 80% or more by mole of the alcohol monomer component to constitute (synthesize) a polyester resin.

Examples of the acid monomer components, such as divalent and polyvalent carboxylic acids, divalent and polyvalent carboxylic anhydrides, and divalent and polyvalent carboxylate esters include, but are not limited to, aromatic dicarboxylic acids, such as phthalic acid, isophthalic acid, and terephthalic acid, and anhydrides thereof;

alkyl dicarboxylic acids, such as succinic acid, adipic acid, sebacic acid, and azelaic acid, and anhydrides thereof; succinic acids substituted with an alkyl or alkenyl group having 6 to 18 carbon atoms and anhydrides thereof; and unsaturated dicarboxylic acids, such as fumaric acid, maleic acid, and citraconic acid, and anhydrides thereof.

Among these, the acid monomer components may be terephthalic acid, succinic acid, adipic acid, fumaric acid, trimellitic acid, pyromellitic acid, benzophenonetetracarboxylic acid, and anhydrides thereof.

The polyester resins preferably have an acid value of 1 mgKOH/g or more and 20 mgKOH/g or less in order to stabilize the triboelectric charging amount of toner.

The acid value of a resin depends on the types and amounts (ratio) of monomers used in the production of the resin. For example, the acid value of a resin depends on the ratio of the alcohol monomer component to the acid monomer component in the production of the resin and the molecular weight of the resin. The acid value of a resin can also be adjusted by a reaction between a terminal alcohol and a polyvalent acid monomer (for example, trimellitic acid) after ester condensation polymerization.

Toner base particles according to an embodiment of the present invention can contain a polymer having a structure formed by a reaction between a vinyl-type resin component and a hydrocarbon compound (such as a polyolefin).

Examples of the polymer having a structure formed by a reaction between a vinyl-type resin component and a hydrocarbon compound include, but are not limited to, graft polymers having a structure in which a polyolefin is grafted on the vinyl-type resin component, and graft polymers having a structure in which the vinyl-type resin component is grafted on a polyolefin.

The polymer having a structure formed by a reaction between a vinyl-type resin component and a hydrocarbon compound functions as a surfactant for melted binder resin and wax in a mixing step or a surface smoothing step in the production of a toner. Thus, the polymer having a structure formed by a reaction between a vinyl-type resin component and a hydrocarbon compound contributes to the control of the particle size of wax dispersed in toner base particles and to the control of the migration rate of wax to a surface of toner base particles in surface treatment with hot air performed if necessary.

In the polymer having a structure formed by a reaction between a vinyl-type resin component and a hydrocarbon compound, the hydrocarbon compound (polyolefin) can be a polymer or copolymer of an unsaturated hydrocarbon-type monomer having a double bond. In particular, the hydrocarbon compound can be polyethylene or polypropylene.

Examples of vinyl-type monomers for use in the production of the vinyl-type resin component include, but are not limited to,

styrene-type monomers, such as styrene and styrene derivatives (substitution products), including styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene;
α-methylene aliphatic monocarboxylate esters having an amino group, such as dimethylaminoethyl methacrylate and diethylaminoethyl methacrylate;
vinyl-type monomers, such as acrylic acid and methacrylic acid derivatives, containing a nitrogen atom, such as acrylonitrile, methacrylonitrile, and acrylamide; unsaturated dibasic acids, such as maleic acid, citraconic acid, itaconic acid, alkenylsuccinic acid, fumaric acid, and mesaconic acid;
unsaturated dibasic acid anhydrides, such as maleic acid anhydride, citraconic acid anhydride, itaconic acid anhydride, and alkenylsuccinic acid anhydride;
unsaturated dibasic acid half esters, such as methyl maleate half ester, ethyl maleate half ester, butyl maleate half ester, methyl citraconate half ester, ethyl citraconate half ester, butyl citraconate half ester, methyl itaconate half ester, methyl alkenyl succinate half ester, methyl fumarate half ester, and methyl mesaconate half ester;
unsaturated dibasic acids, such as dimethylmaleic acid and dimethylfumaric acid;
α,β-unsaturated acids, such as acrylic acid, methacrylic acid, crotonic acid, and cinnamic acid;
α,β-unsaturated acid anhydrides, such as crotonic acid anhydride and cinnamic acid anhydride, and anhydrides between α,β-unsaturated acids and lower fatty acids;
alkenylmalonic acid, alkenylglutaric acid, alkenyladipic acid, acid anhydrides thereof, and vinyl-type monomers having a carboxy group, such as monoesters thereof;
acrylates and methacrylates, such as 2-hydroxyethyl acrylate, 2-hydroxyethyl methacrylate, and 2-hydroxypropyl methacrylate; and vinyl-type monomers having a hydroxy group, such as 4-(1-hydroxy-1-methylbutyl)styrene and 4-(1-hydroxy-1-methylhexyl) styrene;
ester units composed of acrylates, such as acrylates, including methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; and ester units composed of methacrylates, such as α-methylene aliphatic monocarboxylate esters, including methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate.

The polymer having a structure formed by a reaction between a vinyl-type resin component and a hydrocarbon compound can be produced by a reaction between the monomers described above or a reaction between a monomer of one polymer and the other polymer.

The vinyl-type resin component can contain a styrene-type structural unit and can also contain acrylonitrile and/or methacrylonitrile.

In the polymer having a structure formed by a reaction between a vinyl-type resin component and a hydrocarbon compound, the mass ratio of the hydrocarbon compound to the vinyl-type resin component (hydrocarbon compound/vinyl-type resin component) preferably ranges from 1/99 to 75/25. In order to evenly disperse wax in toner base particles, the mass ratio of the hydrocarbon compound to the vinyl-type resin component is preferably adjusted in this range. In the case of heat treatment (surface treatment with hot air) of toner base particles, it is also preferred in terms of the migration rate of wax to a surface of the toner base particles.

The amount of the polymer having a structure formed by a reaction between a vinyl-type resin component and a hydrocarbon compound in toner base particles is preferably 0.2 parts or more and 20 parts or less by mass per 100 parts by mass of a binder resin in the toner base particles. The amount of the polymer having a structure formed by a reaction between a vinyl-type resin component and a hydrocarbon compound is preferably in this range in order to evenly disperse wax in toner base particles. In the case of heat treatment (surface treatment with hot air) of toner base particles, it is also preferred in terms of the migration rate of wax to a surface of the toner base particles.

### [Wax]

Examples of the wax for use in toner base particles according to an embodiment of the present invention include, but are not limited to, hydrocarbon-type waxes, such as low-molecular-weight polyethylene, low-molecular-weight polypropylene, alkylene copolymers, microcrystalline waxes, paraffin waxes, and Fischer-Tropsch waxes;

oxides of hydrocarbon-type waxes, such as oxidized polyethylene waxes, and block copolymers thereof;
waxes composed mainly of fatty acid esters, such as carnauba wax;
fatty acid esters partly or entirely subjected to deacidification, such as deacidified carnauba wax;
saturated straight-chain fatty acids, such as palmitic acid, stearic acid, and montanic acid;
unsaturated fatty acids, such as brassidic acid, eleostearic acid, and parinaric acid;
saturated alcohols, such as stearyl alcohol, aralkyl alcohols, behenyl alcohol, carnaubyl alcohol, ceryl alcohol, and myricyl alcohol;
polyhydric alcohols, such as sorbitol;
esters between fatty acids, such as palmitic acid, stearic acid, behenic acid, and montanic acid, and alcohols, such as stearyl alcohol, aralkyl alcohols, behenyl alcohol, carnaubyl alcohol, ceryl alcohol, and myricyl alcohol;
fatty acid amides, such as linoleamide, oleamide, and lauramide;
saturated fatty acid bisamides, such as methylenebisstearamide, ethylenebiscapramide, ethylenebislauramide, and hexamethylenebisstearamide;
unsaturated fatty acid amides, such as ethylenebisoleamide, hexamethylenebisoleamide, N,N′-dioleyladipamide, and N,N′-dioleylsebacamide;
aromatic bisamides, such as m-xylenebisstearamide and N,N′-distearylisophthalamide;
aliphatic metal salts (generally referred to as metallic soap), such as calcium stearate, calcium laurate, zinc stearate, and magnesium stearate;
aliphatic hydrocarbon-type waxes grafted with vinyl-type monomers, such as styrene and acrylic acid;
partial esters between fatty acids, such as behenic acid monoglyceride, and polyhydric alcohols; and
methyl ester compounds having a hydroxy group produced by hydrogenation of vegetable oils and fats.

Among these, hydrocarbon-type waxes, such as paraffin waxes and Fischer-Tropsch waxes, can improve low-temperature fixability and fixing winding resistance (resistance to winding around a fixing member).

The wax content of toner base particles is preferably 0.5 parts or more and 20 parts or less by mass per 100 parts by mass of a binder resin in the toner base particles.

In order to achieve high storage stability and high-temperature offset resistance of toner, the maximum endothermic peak of the toner in a temperature range of 30° C. or more and 200° C. or less in an endothermic curve during heating measured by differential scanning calorimetry (DSC) preferably has a peak temperature of 50° C. or more and 110° C. or less.

### [Colorant]

Toner base particles according to an embodiment of the present invention can contain a colorant. The colorant may be a pigment alone or a combination of a dye and a pigment. A combination of a dye and a pigment can be used to improve definition and full-color image quality.

Examples of the colorant for use in toner base particles according to an embodiment of the present invention include, but are not limited to, black colorants, such as

carbon black and
a mixture of a yellow colorant, a magenta colorant, and a cyan colorant adjusted to black.

Examples of pigments of the magenta colorant include, but are not limited to,

C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282;

### C.I. Pigment Violet 19; and

### C.I. Vat Red 1, 2, 10, 13, 15, 23, 29, and 35.

Examples of dyes of the magenta colorant include, but are not limited to,

oil-soluble dyes, such as

### C.I. Solvent Red 1, 3, 8, 23, 24, 25, 27, 30, 49, 81, 82, 83, 84, 100, 109, and 121,

### C.I. Disperse Red 9,

### C.I. Solvent Violet 8, 13, 14, 21, and 27, and

### C.I. Disperse Violet 1,

basic dyes, such as

### C.I. Basic Red 1, 2, 9, 12, 13, 14, 15, 17, 18, 22, 23, 24, 27, 29, 32, 34, 35, 36, 37, 38, 39, and 40, and

### C.I. Basic Violet 1, 3, 7, 10, 14, 15, 21, 25, 26, 27, and 28.

Examples of pigments of the cyan colorant include, but are not limited to,

### C.I. Pigment Blue 2, 3, 15:2, 15:3, 15:4, 16, and 17,

### C.I. Vat Blue 6,

### C.I. Acid Blue 45, and

copper phthalocyanine pigments having a phthalocyanine frame substituted with 1 to 5 phthalimidemethyl groups.

Examples of dyes of the cyan colorant include, but are not limited to,

### C.I. Solvent Blue 70.

Examples of pigments of the yellow colorant include, but are not limited to,

### C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and

### C.I. Vat Yellow 1, 3, and 20.

Examples of dyes of the yellow colorant include, but are not limited to,

### C.I. Solvent Yellow 162.

The colorant content of toner base particles is preferably 0.1 parts or more and 30 parts or less by mass per 100 parts by mass of a binder resin in the toner base particles.

### [Charge Control Agent]

Toner base particles according to an embodiment of the present invention can contain a negative or positive charge control agent as an internal or external additive, if necessary.

The charge control agent can be a colorless aromatic carboxylic acid metal compound that provides a high toner charging rate and can stably retain a certain amount of electrical charge. The charge control agent can be a negative charge control agent.

Examples of the negative charge control agent include, but are not limited to,

salicylic acid metal compounds,
naphthoic acid metal compounds,
dicarboxylic acid metal compounds,
polymer-type compounds having sulfonic acid or carboxylic acid on a side chain;
polymer-type compounds having a sulfonate salt or ester on a side chain;
polymer-type compounds having a carboxylate salt or ester on a side chain;
boron compounds;
urea compounds;
silicon compounds; and
calixarene.

The charge control agent may be internally or externally added to toner base particles.

The amount of charge control agent to be used (internal additive amount or external additive amount) is preferably 0.2 parts or more and 10 parts or less by mass per 100 parts by mass of a binder resin in toner base particles.

### [External Additive]

If necessary, an external additive can be added to toner base particles according to an embodiment of the present invention in order to improve the flowability of the toner base particles or adjust the triboelectric charging amount of the toner.

Examples of the external additive include, but are not limited to, inorganic fine particles, such as silicon oxide (silica), titanium oxide, aluminum oxide, and strontium titanate. Inorganic fine particles used as an external additive can be subjected to hydrophobic treatment with a hydrophobizing agent, such as a silane compound, a silicone oil, or a mixture thereof.

In order to prevent an external additive from being buried in toner base particles, the external additive preferably has a specific surface area of 10 m²/g or more and 50 m²/g or less.

The amount of external additive to be used (additive amount or external additive amount) is preferably 0.1 parts or more and 5.0 parts or less by mass per 100 parts by mass of toner base particles.

Toner base particles and an external additive are mixed in a mixer, such as a Henschel mixer.

### [Production Method]

A toner can be produced by any method.

A method for producing a toner by a pulverization process will be described below by way of example.

In a raw material mixing step, predetermined amounts of materials (raw materials) for toner base particles, such as a binder resin, a colorant, a wax, and an optional component, such as a charge control agent, are mixed.

A mixing apparatus, such as a double cone mixer, a V-type mixer, a drum-type mixer, a super mixer, a Henschel mixer, a Nauta mixer, or Mechano Hybrid (manufactured by Nippon Coke & Engineering Co., Ltd.) may be used.

The mixed materials are melt-kneaded to disperse the colorant and the wax in the binder resin. A melt-kneader, for example, a batch-wise kneader, such as a pressure kneader or a Banbury mixer, or a continuous kneader, may be used. Among these, a single-screw extruder or a twin-screw extruder allows continuous production. Examples of such an extruder include, but are not limited to, a KTK-type twin-screw extruder (manufactured by Kobe Steel, Ltd.),

a TEM-type twin-screw extruder (manufactured by Toshiba Machine Co., Ltd.),
a PCM kneader (manufactured by Ikegai Corporation),
a twin-screw extruder (manufactured by KCK Co., Ltd.),
a co-kneader (manufactured by Buss AG), and
Kneadex (manufactured by Nippon Coke & Engineering Co., Ltd.).

A melt-kneaded resin composition may be rolled using a two-roll mill or may be cooled with water.

In a subsequent grinding step, a cooled resin composition is pulverized to a predetermined particle size. In the grinding step, for example, rough crushing using a pulverizer, such as a crusher, a hammer mill, or a feather mill, is followed by pulverization using a Kryptron system (manufactured by Kawasaki Heavy Industries, Ltd.), Super Rotor (manufactured by Nisshin Engineering Inc.), a turbo mill (manufactured by Freund-Turbo Corporation), or an air-jet pulverizer.

After grinding, if necessary, toner base particles are produced after classification using a classifier or sifter, such as inertial classification Elbow-Jet (manufactured by Nittetsu Mining Co., Ltd.) or centrifugal classification Turboplex (manufactured by Hosokawa Micron Corporation), TSP Separator (manufactured by Hosokawa Micron Corporation), or Faculty (manufactured by Hosokawa Micron Corporation).

After grinding, if necessary, toner base particles may be subjected to treatment, such as spheronization treatment using a hybridization system (manufactured by Nara Machinery Co., Ltd.), a Mechanofusion system (manufactured by Hosokawa Micron Corporation), Faculty (manufactured by Hosokawa Micron Corporation), or Meteorainbow MR Type (manufactured by Nippon Pneumatic Mfg. Co., Ltd.).

According to aspects of the present invention, silica fine particles can be adhered to the surfaces of toner base particles produced by the method described above by dispersing the silica fine particles on the surfaces of the toner base particles and subjecting the toner base particles to heat treatment (surface treatment with hot air) while the silica fine particles are dispersed on the surfaces of the toner base particles.

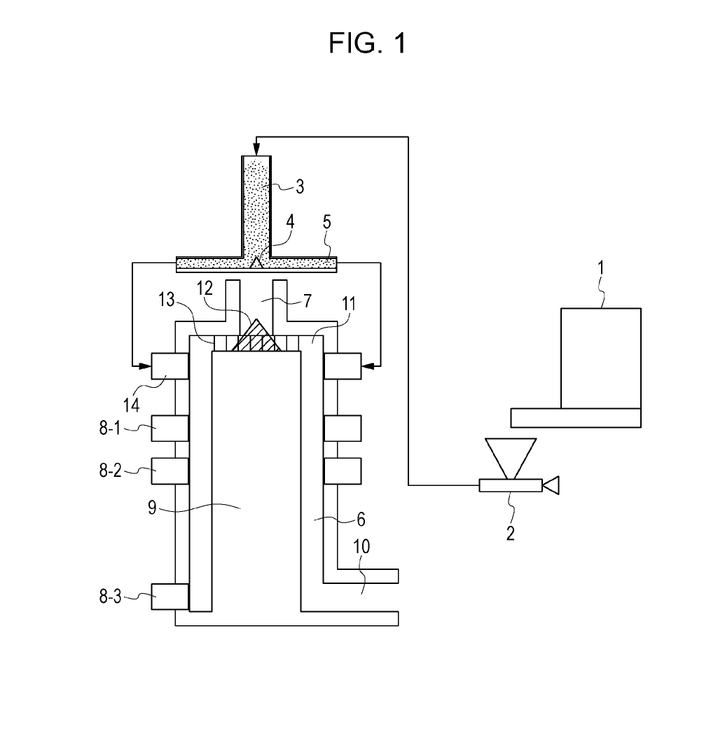

According to aspects of the present invention, for example, a toner is produced by heat treatment (surface treatment with hot air) using a surface treatment apparatus (thermal spheronization treatment apparatus) illustrated in FIG. 1 and, if necessary, by classification.

A predetermined amount of mixture fed by a raw material quantitative supply unit 1 is conveyed into an inlet tube 3 using a compression gas adjusted using a compression gas adjusting unit 2. The inlet tube 3 is disposed on the vertical line of a raw material supply unit. The mixture passing through the inlet tube is evenly dispersed using a conical protruding member 4 disposed at the center of the raw material supply unit, passes through feed pipes 5 that radiate in eight directions, and enters a treatment chamber 6, in which heat treatment is performed.

The flow of the mixture in the treatment chamber 6 is regulated by a regulating unit 9 in the treatment chamber 6. Thus, the mixture in the treatment chamber 6 swirls, is heat-treated, and is then cooled in the treatment chamber 6.

Heat for heat treatment of the mixture in the treatment chamber 6 is supplied from a hot air supply unit 7, is distributed by a distributor 12, and is swirled by a swirler 13 for swirling hot air in the treatment chamber 6. The swirler 13 for swirling hot air has a plurality of blades and can control the swirling of the hot air by means of the number and angle of the blades. The temperature of hot air supplied to the treatment chamber 6 is preferably 100° C. or more and 300° C. or less, more preferably 130° C. or more and 170° C. or less, at an outlet of the hot air supply unit 7. When the temperature of hot air at the outlet of the hot air supply unit 7 is in these ranges, melt-adhesion or coalescence of toner base particles due to excessive heating of the mixture is suppressed, and the toner base particles can be uniformly subjected to spheronization treatment. The toner subjected to the spheronization treatment (heat treatment) preferably has an average circularity of 0.955 or more and 0.980 or less.

Hot air is supplied from a hot air supply unit outlet 11.

The toner base particles after heat treatment (heat-treated toner base particles) are cooled with cool air supplied from a cool air supply unit 8. The temperature of the cool air supplied from the cool air supply unit 8 is preferably −20° C. or more and 30° C. or less. When the temperature of the cool air is in this range, the heat-treated toner base particles can be efficiently cooled, uniform spheronization treatment of the mixture is rarely inhibited, and melt-adhesion or coalescence of the heat-treated toner base particles can be suppressed.

The absolute moisture content of the cool air is preferably 0.5 g/m³ or more and 15.0 g/m³ or less.

The heat-treated toner base particles after cooling is collected by a collecting unit 10 disposed at a lower end of the treatment chamber 6. The collecting unit 10 is coupled to a blower (not shown). The heat-treated toner base particles are drawn and conveyed by the blower.

A powder particle feeding port 14 is provided such that the swirling direction of the supplied mixture coincides with the swirling direction of hot air. The collecting unit 10 of the surface treatment apparatus is disposed on the periphery of the treatment chamber 6 so as to maintain the swirling direction of swirling powder particles. Cool air supplied from the cool air supply unit 8 is horizontally and tangentially supplied from the periphery of the surface treatment apparatus to the inner peripheral surface of the treatment chamber 6. The swirling direction of the toner base particles supplied from the powder particle feeding port 14 before heat treatment, the swirling direction of cool air supplied from the cool air supply unit 8, and the swirling direction of hot air supplied from the hot air supply unit 7 are the same direction. This suppresses turbulence in the treatment chamber 6, enhances the swirl flow in the surface treatment apparatus, produces strong centrifugal force against the toner base particles before heat treatment, and improves the dispersion of the toner base particles before heat treatment. Thus, the heat-treated toner base particles contain fewer coalesced particles and have a uniform shape.

If necessary, surface modification or spheronization treatment may be performed using a hybridization system manufactured by Nara Machinery Co., Ltd. or a Mechanofusion system manufactured by Hosokawa Micron Corporation. If necessary, a sifter, such as a pneumatic sifter Hi-Bolter (manufactured by Shin Tokyo Kikai), may be used.

After that, if necessary, inorganic fine particles may be added to the toner base particles to improve the flowability and charging stability of the toner. A mixing apparatus, such as a double cone mixer, a V-type mixer, a drum-type mixer, a super mixer, a Henschel mixer, a Nauta mixer, or Mechano Hybrid (manufactured by Nippon Coke & Engineering Co., Ltd.) may be used.

Methods for measuring physical properties according to aspects of the present invention will be described below.

[Methods for Measuring Loose Apparent Density ρ_{b} and Tap Density ρₜ of Developer]

Powder Tester PT-R (manufactured by Hosokawa Micron Corporation) was used for the measurement.

First, the loose apparent density ρ_{b} (g/cm³) was measured. A developer subjected to humidity control at 23° C./50% RH for hours was used as a sample. The measurement was performed at 23° C./50% RH. 100 mL of the developer was collected in a 100-mL metal cup through a sifter having an opening of 75 μm vibrated at an amplitude of 1 mm. The loose apparent density ρ_{b} (g/cm³) was calculated from the mass of the sample collected in the metal cup.

The packed apparent density (tap density) ρₜ (g/cm³) was then measured. While a sample was supplied to a metal cup through a sifter having an opening of 75 μm vibrated at an amplitude of 1 mm and overflowed from the metal cup, the metal cup was vertically tapped 180 times at an amplitude of 18 mm. The packed apparent density (tap density) ρₜ (g/cm³) was calculated from the mass of the sample after tapping.

The compressibility Ct was determined using the following equation.

Ct (%)=100×(ρₜ−ρ_{b})/ρₜ

### [Method for Measuring Weight-Average Particle Diameter (D4)]

A toner was subjected to measurement using a precision particle size distribution analyzer (trade name: Coulter Counter Multisizer 3) manufactured by Beckman Coulter, Inc. by an aperture impedance method and using associated dedicated software (trade name: Multisizer 3 Version 3.51 available from Beckman Coulter, Inc.) for measurement condition setting and measured data analysis. The precision particle size distribution analyzer was equipped with a 100 μm aperture tube. The number of effective measuring channels was 25,000. The weight-average particle diameter (D4) of the toner was calculated by analyzing the measured data.

An aqueous electrolyte used in the measurement may be approximately 1% by mass special grade sodium chloride dissolved in ion-exchanged water, for example, ISOTON II (trade name) manufactured by Beckman Coulter, Inc.

Before the measurement and analysis, the dedicated software was set up as described below.

On the “Standard operation mode (SOM) setting screen” of the dedicated software, the total count number in control mode was set at 50,000 particles, the number of measurements was set at 1, and the Kd value was obtained using standard particles 10.0 μm available from Beckman Coulter, Inc. A threshold/noise level measurement button was pushed to automatically set the threshold and noise level. The current was set at 1600 ρA. The gain was set at 2. Isoton II was selected as an electrolyte solution. “Flushing of aperture tube after measurement” was checked.

On the “Conversion of pulse into particle diameter setting screen” of the dedicated software, the bin interval was set at logarithmic particle diameter, the particle diameter bin was set at 256 particle diameter bins, and the particle diameter range was set at 2 to 60 μm.

The following is a specific measurement method.

(1) A 250-mL round-bottom glass beaker for Multisizer 3 was charged with approximately 200 mL of the aqueous electrolyte and was placed on a sample stand. The aqueous electrolyte was stirred counterclockwise using a stirrer rod at 24 revolutions per second. Soiling and air bubbles in the aperture tube were removed using the “Aperture flushing” function of the dedicated software.

(2) A 100-mL flat-bottom glass beaker was charged with approximately 30 mL of the aqueous electrolyte. Approximately 0.3 mL of a solution of Contaminon N (trade name) manufactured by Wako Pure Chemical Industries, Ltd. (a 10% by mass aqueous solution of a neutral detergent for cleaning precision measuring instruments composed of a nonionic surfactant, an anionic surfactant, and an organic builder, pH 7) 3-fold (mass ratio) diluted with ion-exchanged water was added to the aqueous electrolyte as a dispersant.

(3) A predetermined amount of ion-exchanged water was poured into a water tank of an ultrasonic homogenizer (trade name: Ultrasonic Dispersion System Tetora 150) having an electrical output of 120 W manufactured by Nikkaki-Bios Co., Ltd. Approximately 2 mL of Contaminon N was added to the water tank. The ultrasonic homogenizer includes two oscillators having an oscillation frequency of 50 kHz. The two oscillators have a phase difference of 180 degrees.

(4) The beaker prepared in (2) was placed in a beaker-holding hole in the ultrasonic disperser, and the ultrasonic disperser was actuated. The vertical position of the beaker was adjusted such that the surface resonance of the aqueous electrolyte in the beaker was highest.

(5) While the aqueous electrolyte in the beaker prepared in (4) was exposed to ultrasonic waves, approximately 10 mg of toner was added little by little to the aqueous electrolyte and was dispersed. The ultrasonic dispersion treatment was continued for another 60 seconds. During the ultrasonic dispersion, the water temperature of the water tank was controlled at a temperature of 10° C. or more and 40° C. or less.

(6) The aqueous electrolyte containing dispersed toner produced in (5) was added dropwise using a pipette into the round-bottom beaker prepared in (1) placed on the sample stand such that the measurement concentration was approximately 5%. Measurement was continued until the number of measured particles reached 50,000.

(7) The measured data were analyzed using the associated dedicated software, and the weight-average particle diameter D4) was determined. The weight-average particle diameter (D4) is the “Average diameter” on an analysis/volume statistics (arithmetic mean) screen in the setting of graph/volume percent in the dedicated software.

### [Method for Measuring Average Circularity of Toner]

The average circularity of a toner was measured using a flow particle image analyzer (trade name: FPIA-3000) manufactured by SYSMEX Corporation under the measurement conditions and analysis conditions for calibration.

The following is a specific measurement method.

First, a glass container was charged with approximately 20 mL of ion-exchanged water from which solid impurities were removed in advance. Approximately 0.2 mL of a solution of Contaminon N 3-fold (mass ratio) diluted with ion-exchanged water was added to the glass container as a dispersant. Approximately 0.02 g of a toner sample was also added to the glass container and was dispersed using an ultrasonic homogenizer for 2 minutes, thus preparing a dispersion liquid for measurement. During the dispersion, the dispersion liquid was adjusted to a temperature of 10° C. or more and 40° C. or less. The ultrasonic homogenizer was a table-top ultrasonic cleaner disperser having an oscillation frequency of 50 kHz and an electrical output of 150 W (for example, “VS-150” (manufactured by Velvo-Clear)). Approximately 2 mL of Contaminon N was added to a predetermined amount of ion-exchanged water in a water tank.

The flow particle image analyzer equipped with an objective lens “UPlanApro” (magnification: 10, numerical aperture: 0.40) was used for the measurement. A particle sheath (trade name: PSE-900A) manufactured by SYSMEX Corporation was used as a sheath liquid.

The dispersion liquid prepared by following the procedure described above was introduced into the flow particle image analyzer, and 3000 toner base particles were measured in an HPF measurement mode and a total count mode. The binarization threshold in particle analysis was set at 85%. The particle diameter to be analyzed was limited to a circle-equivalent diameter of 1.985 μm or more and less than 39.69 μm. The average circularity of the toner was determined.

Before measurement, automatic focusing control was performed using standard latex particles (for example, RESEARCH AND TEST PARTICLES Latex Microsphere Suspensions 5200A (trade name) manufactured by Duke Scientific Corp. diluted with ion-exchanged water). Focusing was adjusted every 2 hours after the start of measurement.

The flow particle image analyzer was calibrated by SYSMEX Corporation and was issued with a calibration certificate from SYSMEX Corporation. Measurement was performed under the measurement and analysis conditions for calibration certificate except that the particle diameter to be analyzed was limited to a circle-equivalent diameter in the range of 1.985 μm or more and less than 39.69 μm.

The measurement principle of the FPIA-3000 is that flowing particles are captured as a still image, which is subjected to image analysis. A sample (particles) in a sample chamber is fed into a flat sheath flow cell using a sample suction syringe. The sample in the flat sheath flow forms a flat flow between sheath liquid flows. The sample passing through the flat sheath flow cell is irradiated with stroboscopic light at intervals of 1/60 seconds. Thus, flowing particles can be captured as a still image. It is easy to bring the flat flow into focus. Particle images are taken using a CCD camera. The images are subjected to image processing at an image processing resolution of 512×512 pixels (0.37 μm×0.37 μm per pixel). Each particle image is subjected to outline extraction to measure the projected area S and perimeter L of the particle image.

The circle-equivalent diameter and circularity were calculated from the area S and the perimeter L. The circle-equivalent diameter refers to the diameter of a circle having the same area as the projected area of a particle image. The circularity is defined as a value determined by dividing the perimeter of a circle calculated from the circle-equivalent diameter by the perimeter of the particle projection image and is calculated using the following equation.

Circularity=2×(π×S)^{1/2}/L

A circular particle image has a circularity of 1.000. The circularity decreases with increasing unevenness of the periphery of a particle image. After the circularity of each particle is calculated, an area having a circularity in the range of 0.200 to 1.000 is divided into 800 sections. The arithmetic mean of the circularities is calculated as an average circularity.

[Image-Forming Apparatus in which Developer Supply Cartridge is Used]

The basic structure of an image-forming apparatus in which a developer supply cartridge according to an embodiment of the present invention is used will be described below. Subsequently, the structure of a developer supply system to be installed in the image-forming apparatus, that is, a developer supply apparatus and a developer supply kit will be described below.

### [Image-Forming Apparatus]

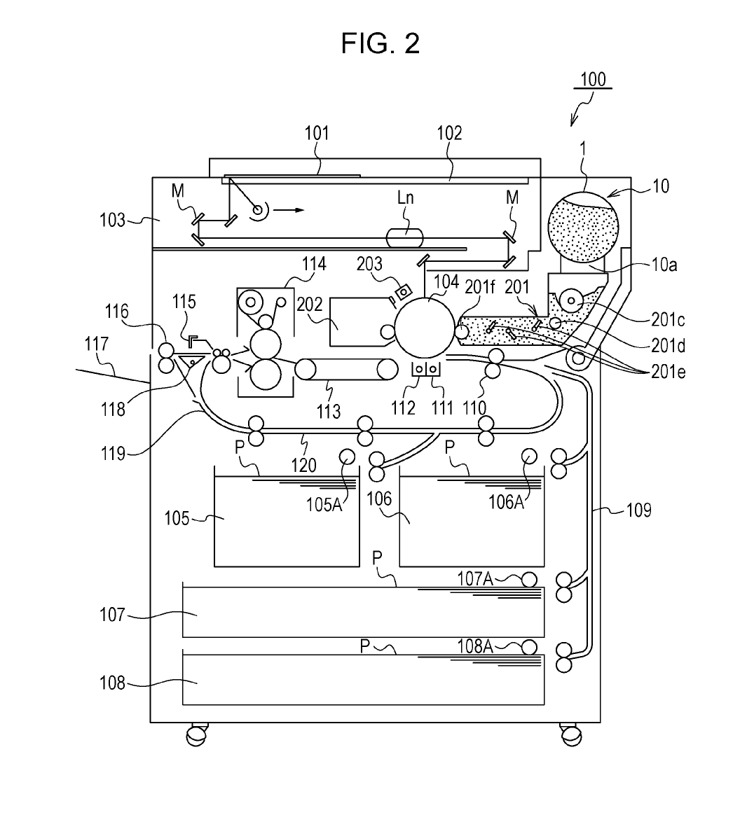

The structure of an image-forming apparatus (copying machine) utilizing electrophotography will be described below with reference to FIG. 2 as an example of an image-forming apparatus that includes a developer supply apparatus to which a developer supply cartridge is detachably attachable.

FIG. 2 is a cross-sectional view of the entire structure of an image-forming apparatus (copying machine).

In FIG. 2, the image-forming apparatus includes a main body 100. An original 101 is disposed on an original base plate glass 102. An optical image based on the image information of the original is formed on a surface of an electrophotographic photosensitive member 104 (hereinafter also referred to as a “photosensitive member”) using a plurality of mirrors M and a lens Ln in an optical unit 103, thereby forming an electrostatic latent image on a surface of the photosensitive member 104.

The electrostatic latent image is developed (visualized) with a toner developer by a developing unit 201 and forms a toner image on a surface of the photosensitive member 104.

111 denotes a charging device for transfer, and 112 denotes a detach charger.

The toner image on the surface of the photosensitive member 104 is transferred to a transfer material (a sheet, such as paper) S by the charging device for transfer 111. The transfer material S to which the toner image has been transferred is separated from the photosensitive member 104 by the detach charger 112.

The transfer material S conveyed by a conveying unit 113 is then subjected to heat and pressure in a fixing unit 114. After the toner image on the transfer material S is thereby fixed, the transfer material S is discharged onto a discharge tray 117 by discharge rollers 116.

The main body 100 of the image-forming apparatus includes image forming process devices, such as the developing unit 201 as a developing device, a cleaner 202 as a cleaning device, and a primary charger 203 as a charging device, around the photosensitive member 104. The developing unit 201 provides adhesion of the developer (toner) to the electrostatic latent image formed on the photosensitive member 104 by the optical unit 103 based on the image information of the original 101 and thereby develops the electrostatic latent image. The primary charger 203 uniformly charges the surface of the photosensitive member 104 in order to form a desired electrostatic latent image on the surface of the photosensitive member 104. The cleaner 202 removes the residual developer (toner) from the surface of the photosensitive member 104 after the toner image is transferred to the transfer material S.

### [Developer Supply Apparatus]

A developer supply apparatus, which is a component of a developer supply system, will be described below with reference to FIG. 2 to FIGS. 4A to 4C.

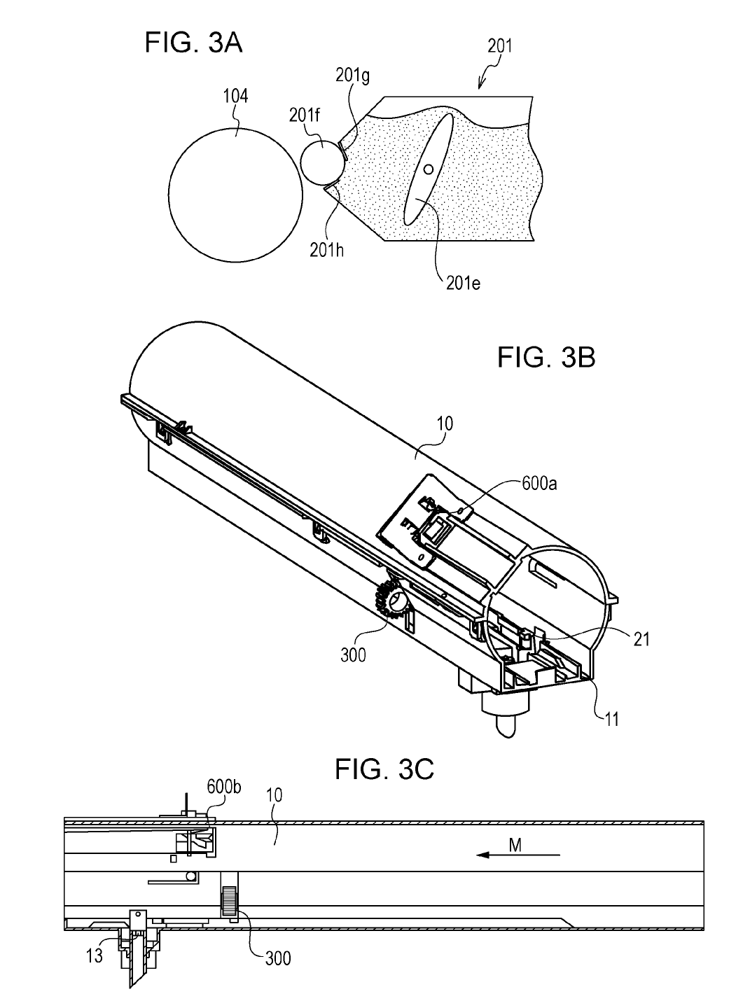

FIG. 3A is a fragmentary sectional view of the developing unit 201. FIG. 3B is a perspective view of a holder 10 for the developer supply container 1. FIG. 3C is a cross-sectional view of the holder 10.

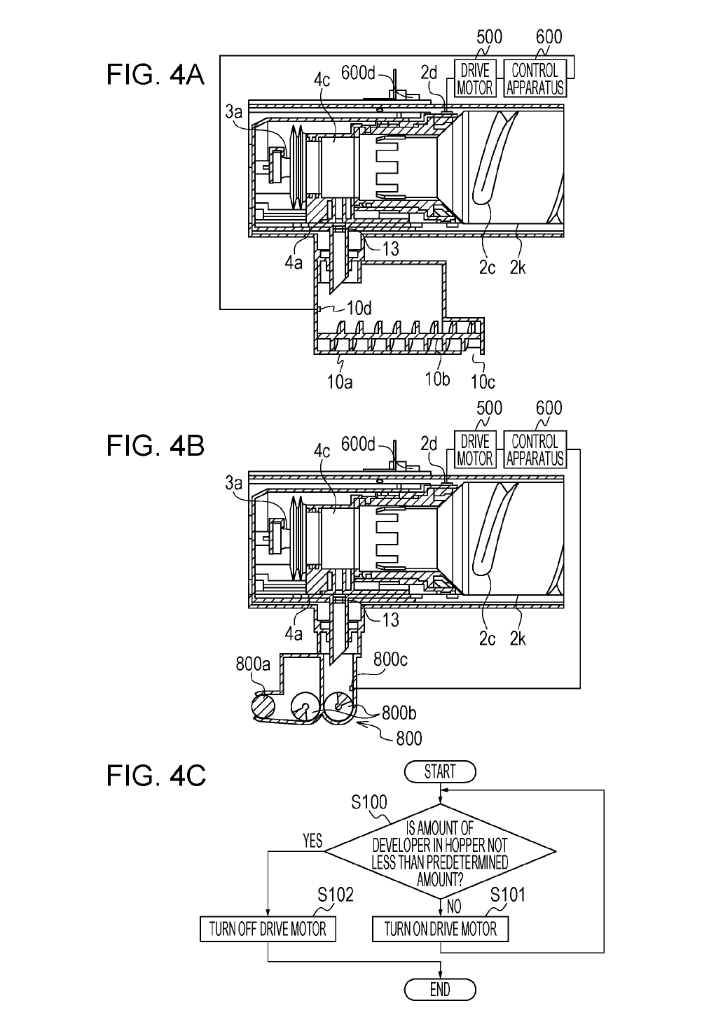

FIG. 4A is an enlarged cross-sectional view of a developer supply container and a developer supply apparatus. FIG. 4B is an enlarged cross-sectional view of another developer supply container and developer supply apparatus.

The developer supply apparatus includes the holder (holding space) 10 to which the developer supply container 1 is detachably attached (detachably attachable), a hopper 10a for temporarily storing a developer discharged from the developer supply container 1, and the developing unit 201.

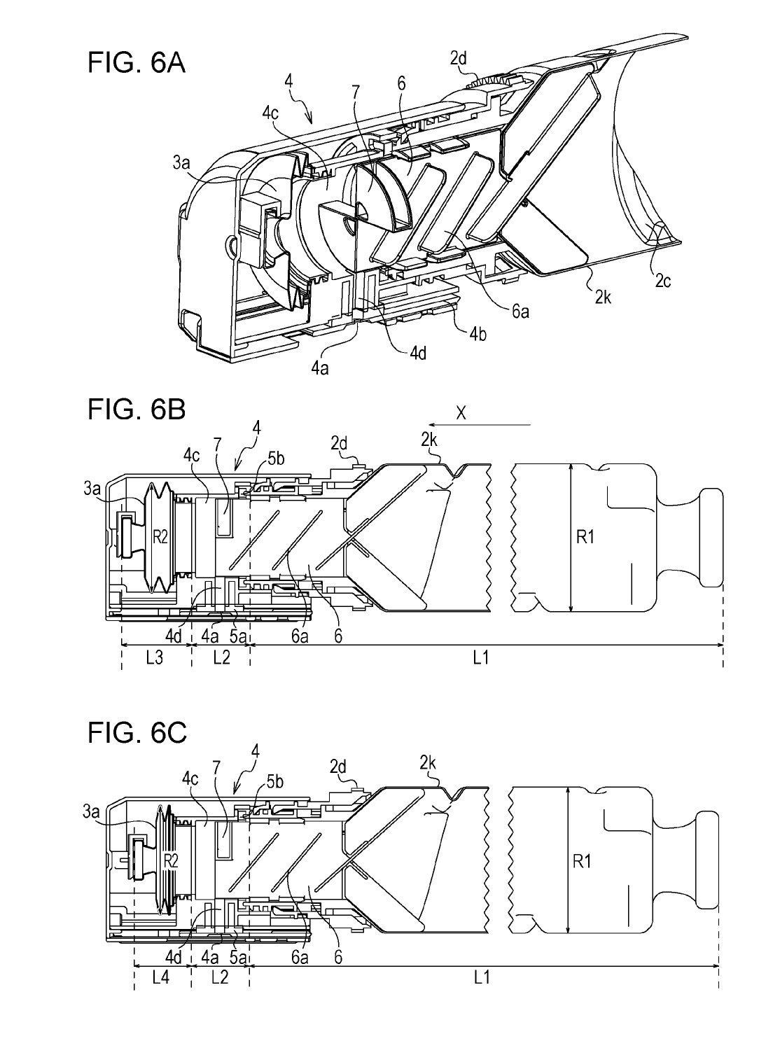

As illustrated in FIG. 3C, the developer supply container 1 is placed in the holder 10 in the M direction. More specifically, the developer supply container 1 is placed in the holder 10 such that the longitudinal direction (the rotation axis direction) of the developer supply container 1 substantially coincides with the M direction. The M direction is substantially parallel to the X direction described below in FIG. 6B. The developer supply container 1 is removed from the holder 10 in the direction opposite to the M direction.

As illustrated in FIG. 2 and FIG. 3A, the developing unit 201 includes a developing roller 201f, a stirring member 201c, and feed members 201d and 201e. A developer supplied from the developer supply container 1 is stirred by the stirring member 201c, is fed to the developing roller 201f by the feed members 201d and 201e, and is supplied to the photosensitive member 104 by the developing roller 201f.

The developing roller 201f is provided with a developing blade 201g for regulating the amount of developer on the roller and a leakage preventing sheet 201h in contact with the developing roller 201f. The leakage preventing sheet 201h prevents the developer from leaking from the developing unit 201.

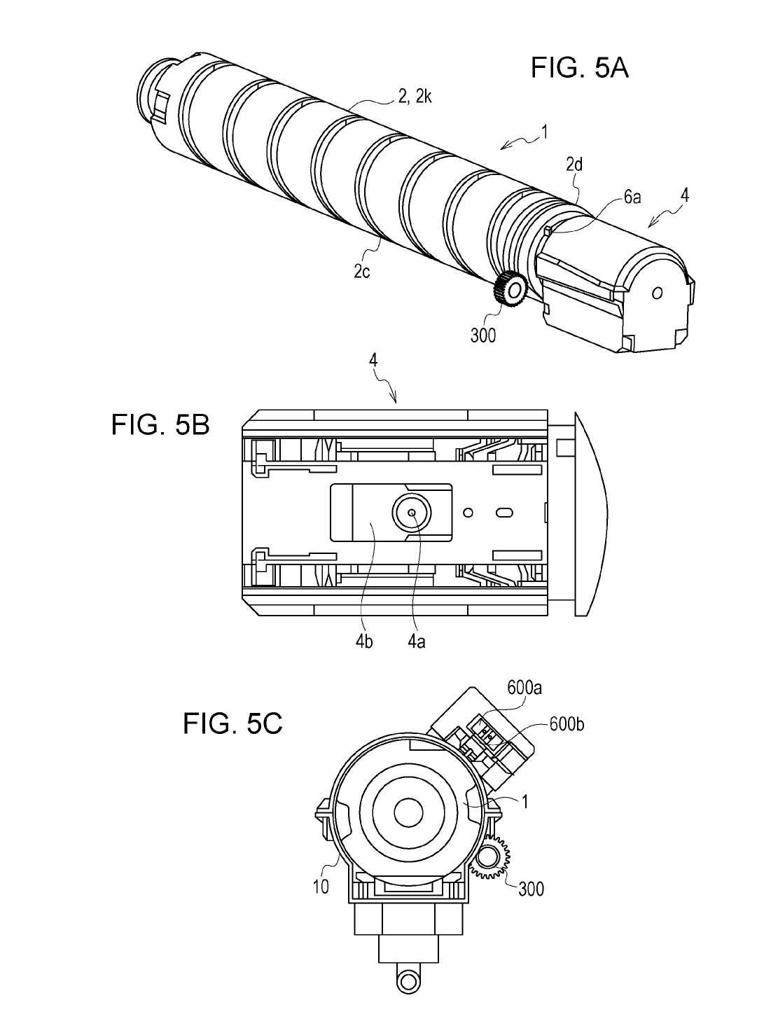

As illustrated in FIG. 3B, the holder 10 includes a rotational direction restricting portion (retention mechanism) 11, which comes into contact with a flange 4 of the developer supply container 1 (see FIG. 5A) and thereby restricts the rotation of the flange 4.

The holder 10 includes a developer receiving port 13 for receiving a developer from the developer supply container 1. The developer receiving port 13 can communicate with a discharging port (discharging pore) 4a of the developer supply container 1 (see FIG. 5B) described below. A developer is supplied to the developing unit 201 through the discharging port 4a of the developer supply container 1 and the developer receiving port 13.

In the present embodiment, in order to minimize soiling of the inside of the holder 10 with a developer, the developer receiving port 13 is a small opening (pinhole) having a diameter of approximately 3 mm. The developer receiving port may have any diameter at which a developer can be discharged from the discharging port 4a.

As illustrated in FIG. 4A, the hopper 10a includes a conveying screw 10b for conveying a developer to the developing unit 201, an opening 10c in communication with the developing unit 201, and a developer sensor 10d for detecting the developer in the hopper 10a.

As illustrated in FIGS. 3B and 3C, the holder 10 includes a drive gear 300, which functions as a driving mechanism (drive unit). Rotational driving force is transmitted from a drive motor 500 (not shown) to the drive gear 300 via a series of drive gears. The drive gear 300 functions to apply the rotational driving force to the developer supply container 1 placed in the holder 10.

As illustrated in FIG. 4A, the operation of the drive motor 500 is controlled by a controller (CPU) 600. As illustrated in FIG. 4A, on the basis of information on the developer remaining amount input by the developer sensor 10d, the controller 600 controls the operation of the drive motor 500.

In the present embodiment, in order to simplify the control of the drive motor 500, the drive gear 300 rotates in one direction. More specifically, the controller 600 only controls the on (start) and off (stop) of the drive motor 500. Thus, the driving mechanism of the developer supply apparatus can be simplified, as compared with a structure in which turning driving force produced by periodically reversing the rotation of the drive motor 500 (the drive gear 300) in the opposite directions is applied to the developer supply container 1.

### [Method for Mounting and Removing Developer Supply Container]

A method for mounting and removing the developer supply container 1 will be described below.

An operator opens a cover and inserts the developer supply container 1 into the holder 10 of the developer supply apparatus. Through this mounting operation, the flange 4 of the developer supply container 1 is held and fixed in the developer supply apparatus.

After that, the operator closes the cover to complete a mounting step. After that, the controller 600 controls the drive motor 500 to rotate the drive gear 300 at the appropriate time.

When the developer in the developer supply container 1 has been consumed, the operator opens the cover and takes the developer supply container 1 out of the holder 10. The operator inserts a new developer supply container 1 prepared in advance into the holder 10 to complete the replacement procedure, which includes removal of the developer supply container 1 and mounting of the new developer supply container 1.

### [Developer Supply Control by Developer Supply Apparatus]

Developer supply control by a developer supply apparatus will be described below with reference to FIG. 4C.

FIG. 4C is a flow chart of a developer supply flow.

The developer supply control is performed by controlling various devices using the controller (CPU) 600.

In the present embodiment, the controller 600 controls the start and stop of the drive motor 500 on the basis of the output from the developer sensor 10d so as to prevent loading of an excessive amount of developer in the hopper 10a.

More specifically, the developer sensor 10d checks for a developer in the hopper 10a (S100). When the developer sensor 10d does not detect the developer (when the developer level is below a predetermined level), the drive motor 500 is driven for a predetermined period to perform the developer supply operation (S101).

When the developer sensor 10d detects the developer during the developer supply operation (when the developer level reaches the predetermined level), the drive motor 500 is stopped to terminate the developer supply operation (S102). A developer supply step is completed by the termination of the supply operation.

When the developer is consumed by image formation, and the level of the developer in the hopper 10a decreases below the predetermined amount, the developer supply step is performed again.

Although a developer discharged from the developer supply container 1 may be temporarily stored in the hopper 10a and then supplied to the developing unit 201, the developer supply apparatus in the present embodiment has the following structure.

As illustrated in FIG. 4B, a developer is directly supplied from the developer supply container 1 to the developing unit 201 without the hopper 10a.

In FIG. 4B, a two-component developing unit 800 is used as a developer supply apparatus.

The developing unit 800 includes a stirring chamber to which a developer is supplied and a developing chamber for supplying the developer to a developing sleeve 800a. A stirring screw 800b is disposed in the stirring chamber and the developing chamber. The developer conveying directions of the stirring screws 800b are opposite. The stirring chamber communicates with the developing chamber in the longitudinal direction, and a two-component developer circulates through these two chambers.

The stirring chamber includes a magnetic sensor 800c for determining the concentration of toner in the two-component developer. On the basis of the concentration determined by the magnetic sensor 800c, the controller 600 controls the operation of the drive motor 500. In this structure, the developer supplied from the developer supply container is a non-magnetic toner, or a non-magnetic toner and a magnetic carrier.

In the present embodiment, as described below, almost no developer in the developer supply container 1 is discharged through the discharging port 4a due to gravitation alone. The developer is discharged by the volume change operation of a pump unit 3a. This can decrease variations in discharge amount. Thus, the hopper 10a can be omitted, and a developer can be consistently supplied to the developing chamber without the hopper.

### [Developer Supply Container]

The structure of the developer supply container 1, which is a component of a developer supply system, will be described below with reference to FIGS. 5A to 5C and FIGS. 6A to 6C.

FIG. 5A is an overall perspective view of the developer supply container 1, FIG. 5B is a fragmentary enlarged view of the periphery of the discharging port 4a of the developer supply container 1, and FIG. 5C is a front view of the developer supply container 1 in the holder 10 of the developer supply apparatus.

FIG. 6A is a cross-sectional perspective view of the developer supply container, FIG. 6B is a fragmentary sectional view in which the pump unit is fully expanded, and FIG. 6C is a fragmentary sectional view in which the pump unit is fully contracted.

As illustrated in FIG. 5A, the developer supply container 1 is a hollow tube and includes a developer accommodation section 2 having an internal space for accommodating a developer (hereinafter also referred to as a “main body of a container”). In the present embodiment, a cylindrical portion 2k, a discharge section 4c (see FIGS. 6A to 6C), and a pump unit 3a (see FIGS. 6A to 6C) function as the developer accommodation section 2. The developer supply container 1 further includes the flange 4 (hereinafter also referred to as an “irrotational portion”) at one end of the developer accommodation section 2 in the longitudinal direction (the developer conveying direction). The cylindrical portion 2k is rotatable relative to the flange 4. The cylindrical portion 2k may have a noncircular cross-section, provided that it does not affect rotation in the developer supply step. For example, the cylindrical portion 2k may have an elliptical or polygonal cross-section.

In the present embodiment, as illustrated in FIG. 6B, the cylindrical portion 2k, which functions as a developer accommodating chamber, has a total length L1 of approximately 460 mm and an outer diameter R1 of approximately 60 mm. A region including the discharge section 4c, which functions as a developer discharging chamber, has a length L2 of approximately 21 mm. The pump unit 3a has a total length L3 of approximately 29 mm (when fully expanded in the expansion and contraction range during use). As illustrated in FIG. 6C, the pump unit 3a has a total length L4 of approximately 24 mm (when fully contracted in the expansion and contraction range during use).

In the present embodiment, as illustrated in FIGS. 5A to 5C and FIGS. 6A to 6C, the cylindrical portion 2k and the discharge section 4c of the developer supply container 1 in developer supply apparatus are aligned in the horizontal direction. In other words, the cylindrical portion 2k has a much longer horizontal length than its vertical length and is coupled to the discharge section 4c in the horizontal direction. This can decrease the amount of developer on the discharging port 4a described below, as compared with a structure in which the cylindrical portion 2k is disposed in the vertical direction on the discharge section 4c of the developer supply container 1 in the developer supply apparatus. This prevents the developer in the vicinity of the discharging port 4a from being excessively compressed and allows smooth intake and exhaust operations.

### [Material of Developer Supply Container]

In the present embodiment, as described below, the pump unit 3a changes the volume of the developer supply container 1 and discharges a developer through the discharging port 4a. Thus, the developer supply container 1 can be made of a rigid material so as not to be significantly collapsed or expanded due to volume changes.

In the present embodiment, the inside of the developer supply container 1 communicates with the outside only through the discharging port 4a and is insulated from the outside except the discharging port 4a. More specifically, since the pump unit 3a decreases or increases the volume of the developer supply container 1 to discharge a developer through the discharging port 4a, some degree of hermeticity is required for stable discharge.

In the present embodiment, therefore, the developer accommodation section 2 and the discharge section 4c are made of a polystyrene resin, and the pump unit 3a is made of a polypropylene resin.

The developer accommodation section 2 and the discharge section 4c can be made of a material that can withstand volume changes. Examples of such a material include, but are not limited to, acrylonitrile butadiene styrene (ABS) copolymers, polyesters, polyethylene, and polypropylene, in addition to the materials described above. The material may be a metal.

The pump unit 3a can be made of a material that can expand and contract and can change its volume, thereby changing the volume of the developer supply container 1. For example, the pump unit 3a can be made of a thin acrylonitrile butadiene styrene (ABS) copolymer, polystyrene, polyester, or polyethylene film. Rubbers and other elastic materials may also be used.

Provided that the pump unit 3a, the developer accommodation section 2, and the discharge section 4c have the functions described above, they may be made of the same resin material having different thicknesses and may be integrally formed by injection molding or blow molding.

The structures of the flange 4, the cylindrical portion 2k, the pump unit 3a, a drive receiving mechanism 2d, and a drive conversion mechanism 2e (cam groove) of the developer supply container 1 will be described below.

### [Flange]

As illustrated in FIGS. 6A and 6B, the flange 4 includes the hollow discharge section (developer discharging chamber) 4c for temporarily accommodating a developer conveyed from the cylindrical portion 2k. The small discharging port 4a through which a developer is discharged from the developer supply container 1, that is, through which the developer supply apparatus is supplied with a developer is disposed at the bottom of the discharge section 4c. A developer storage section 4d for storing a certain amount of developer before discharge is disposed on the discharging port 4a. The size of the discharging port 4a will be described later.

The flange 4 further includes a shutter 4b for opening and closing the discharging port 4a. When the developer supply container 1 is inserted into the holder 10, the shutter 4b comes into contact with a bump 21 (see FIG. 3B) of the holder 10. Thus, when the developer supply container 1 is inserted into the holder 10, the shutter 4b slides relative to the developer supply container 1 in the rotation axis direction of the cylindrical portion 2k (in the direction opposite to the M direction in FIG. 3C). Consequently, the shutter 4b is opened to expose the discharging port 4a, thus completing the opening operation.

Because the discharging port 4a coincides with the developer receiving port 13 of the holder 10, the discharging port 4a communicates with the developer receiving port 13, thereby allowing a developer to be supplied from the developer supply container 1.

When the developer supply container 1 is disposed in the holder 10 of the developer supply apparatus, the flange 4 is substantially immovable.

More specifically, the rotational direction restricting portion 11 illustrated in FIG. 3B prevents the flange 4 from rotating in the rotational direction of the cylindrical portion 2k.

Thus, while the developer supply container 1 is disposed in the developer supply apparatus, the discharge section 4c of the flange 4 is also substantially prevented from rotating in the rotational direction of the cylindrical portion 2k (except backlash and play).

On the other hand, the cylindrical portion 2k is not prevented from rotating in the rotational direction by the developer supply apparatus and can rotate during the developer supply step.

As illustrated in FIGS. 6A to 6C, a developer conveyed by a spiral protruded portion (conveying protrusion) 2c from the cylindrical portion 2k is conveyed to the discharge section 4c by a plate-like conveying member 6. The conveying member 6 divides a region in the developer accommodation section 2 into approximately two regions and rotates simultaneously with the cylindrical portion 2k. The conveying member 6 includes a plurality of inclined ribs 6a on both sides thereof. The ribs 6a are inclined toward the discharge section 4c with respect to the rotation axis direction of the cylindrical portion 2k. A suppression part 7 is disposed at an end of the conveying member 6. The suppression part 7 will be described in detail later.

Thus, the plate-like conveying member 6 vertically raises a developer conveyed by the conveying protrusion 2c simultaneously with the rotation of the cylindrical portion 2k. With the rotation of the cylindrical portion 2k, the developer slips down the conveying member 6 due to gravity and is conveyed to the discharge section 4c by the inclined ribs 6a. The inclined ribs 6a are disposed on both sides of the conveying member 6 such that the developer is conveyed to the discharge section 4c every time the cylindrical portion 2k makes a half turn.

### [Discharging Port of Flange]

In the present embodiment, the size of the discharging port 4a of the developer supply container 1 is adjusted such that a developer is not sufficiently discharged due to gravitation alone when the developer supply container 1 supplies the developer supply apparatus with the developer. More specifically, the opening size of the discharging port 4a is small enough to insufficiently discharge a developer from the developer supply container due to gravitation alone (also referred to as a “small opening (pinhole)”). In other words, the discharging port 4a has an opening that is substantially blocked with a developer. This can have the following effects.

(1) Leakage of a developer from the discharging port 4a can be decreased.

(2) Excessive discharge of a developer upon the opening of the discharging port 4a can be suppressed.

(3) Discharge of a developer can depend predominantly on the exhaust operation of the pump unit 3a.

The discharging port can have a diameter of not more than 4 mm (opening area: 12.6 mm², π=3.14, the same applies hereinafter). A discharging port diameter of more than 4 mm may result in drastically increased discharges and unstable supply. Furthermore, a developer may leak from the discharging port due to gravitation.

The smallest size of the discharging port 4a can be such that a developer (a magnetic toner for a one-component developer, a non-magnetic toner for a one-component developer, or a non-magnetic toner and a magnetic carrier for a two-component developer) to be supplied from the developer supply container 1 can pass therethrough. In other words, the discharging port 4a can be greater than the particle size of a developer (the volume-average particle size of a toner or the number-average particle size of a carrier) in the developer supply container 1. For example, when the developer to be supplied contains a non-magnetic toner and a magnetic carrier for a two-component developer, the discharging port 4a can be greater than the larger particle size, that is, the number-average particle size of the magnetic carrier.

More specifically, when the developer to be supplied contains a non-magnetic toner (volume-average particle size: 5.5 μm) and a magnetic carrier (number-average particle size: 40 μm) for a two-component developer, the discharging port 4a preferably has a diameter of 0.05 mm (opening area: 0.002 mm²) or more.

When the size of the discharging port 4a is close to the particle size of the developer, however, this results in increased energy for discharging a predetermined amount of developer from the developer supply container 1 or increased energy for operating the pump unit 3a. This may also limit the production of the developer supply container 1. More specifically, in the case that the discharging port 4a is formed in a resin component by injection molding, part of a mold corresponding to the discharging port 4a has limited endurance. Thus, the discharging port 4a preferably has a diameter of 0.5 mm or more.

Although the discharging port 4a is circular in the present embodiment, the discharging port 4a may be square, rectangular, elliptical, or in a shape composed of straight lines and curved lines, provided that the discharging port 4a has an opening area of not more than 12.6 mm², which corresponds to a diameter of 4 mm.

For the same opening area, a circular discharging port has the smallest circumferential length of the opening, which is soiled with the developer. This decreases the amount of developer spreading due to the opening and closing operation of the shutter 4b and decreases soiling. A circular discharging port has low discharge resistance and the highest dischargeability. Thus, the discharging port 4a having a circular opening has the best balance between the discharge amount and suppression of soiling.

As described above, the size of the discharging port 4a can be such that a developer is not sufficiently discharged due to gravitation alone while the discharging port 4a faces downward (while the developer is supplied to the developer supply apparatus). More specifically, the discharging port 4a preferably has a diameter of 0.05 mm (opening area: 0.002 mm²) or more and 4 mm (opening area: 12.6 mm²) or less. More preferably, the discharging port 4a has a diameter of 0.5 mm (opening area: 0.2 mm²) or more and 4 mm (opening area: 12.6 mm²) or less. Thus, the discharging port 4a in the present embodiment is circular and has an opening diameter of 2 mm.

Although the number of the discharging port 4a is one in the present embodiment, it may be two or more, provided that each opening area is in the range described above. For example, for one developer receiving port 13 having a diameter of 3 mm, two discharging ports 4a each having a diameter of 0.7 mm can be provided. However, this tends to result in a decreased discharge amount of developer (per unit time), as compared with one discharging port 4a having a diameter of 2 mm.

### [Cylindrical Portion]

The cylindrical portion 2k, which functions as a developer accommodating chamber, will be described below with reference to FIGS. 5A to 5C and FIGS. 6A to 6C.

As illustrated in FIGS. 5A to 5C and FIGS. 6A to 6C, the cylindrical portion 2k includes the spiral conveying protrusion 2c on the inner surface thereof. The spiral conveying protrusion 2c can convey a developer to the discharge section 4c (the discharging port 4a) by rotation. The discharge section 4c functions as a developer discharging chamber. The cylindrical portion 2k is formed from the resin described above by blow molding.

The volume of the discharge section 4c of the developer accommodation section 2 may be increased in the height direction in order to increase the volume of the developer supply container 1 and the loading weight. However, this increases gravity acting on the developer in the vicinity of the discharging port 4a due to the weight of the developer. Consequently, the developer in the vicinity of the discharging port 4a may be compressed, and the compressed developer obstructs intake and exhaust through the discharging port 4a. In this case, in order to loosen the compressed developer by intake through the discharging port 4a or discharge the developer by exhaust through the discharging port 4a, it is necessary to increase the volume change of the pump unit 3a. However, this may increase the driving force to drive the pump unit 3a, resulting in an excessive load on the main body 100 of the image-forming apparatus.

In the present embodiment, the cylindrical portion 2k aligns with the flange 4 in the horizontal direction, and the loading weight depends on the volume of the cylindrical portion 2k. Thus, the thickness of the developer layer on the discharging port 4a in the developer supply container 1 can be smaller than the thickness in the structure described above. This prevents the developer from being excessively compressed by gravitation and allows stable discharge of the developer without an excessive load on the main body of the image-forming apparatus.

As illustrated in FIGS. 6B and 6C, the cylindrical portion 2k is rotatable relative to the flange 4 while a flange seal 5b, which is a ring-shaped seal member on the inner surface of the flange 4, is compressed.

The cylindrical portion 2k rotates in contact with the flange seal 5b, and the developer does not leak during the rotation. Thus, the cylindrical portion 2k is hermetically sealed. Air can properly enter and exit through the discharging port 4a, and the volume of the developer supply container 1 can be desirably changed during supply.

### [Pump Unit]

The (reciprocating) pump unit 3a, which can change its volume with reciprocating movement, will be described below with reference to FIGS. 6A to 6C.

FIG. 6A is a cross-sectional perspective view of the developer supply container, FIG. 6B is a fragmentary sectional view in which the pump unit is fully expanded, and FIG. 6C is a fragmentary sectional view in which the pump unit is fully contracted.

The pump unit 3a in the present embodiment functions as an intake and exhaust mechanism that alternately performs intake and exhaust operations through the discharging port 4a. In other words, the pump unit 3a functions as an airflow generating mechanism that alternately generates an airflow toward the inside of the developer supply container through the discharging port 4a and an airflow toward the outside of the developer supply container through the discharging port 4a.

As illustrated in FIG. 6B, the pump unit 3a extends from the discharge section 4c in the X direction. The pump unit 3a and the discharge section 4c do not rotate in the rotational direction of the cylindrical portion 2k.

The pump unit 3a in the present embodiment can store a developer. As described below, a developer accommodating space in the pump unit 3a plays a large role in fluidizing a developer in the intake operation.

The pump unit 3a in the present embodiment is a volume variable type pump unit (bellows pump) made of a resin. The pump unit 3a can change its volume with reciprocating movement. More specifically, as illustrated in FIGS. 6A to 6C, the bellows pump includes alternating “mountain fold” portions and “valley fold” portions at regular intervals. Thus, the pump unit 3a can contract and expand alternately by the driving force received from the developer supply apparatus.

In the present embodiment, the volume change of the pump unit 3a due to expansion and contraction is 5 cm³ (cc). L3 in FIG. 6B is approximately 29 mm, and L4 in FIG. 6C is approximately 24 mm. The pump unit 3a has an outer diameter R2 of approximately 45 mm.

The pump unit 3a can change the volume of the developer supply container 1 at predetermined intervals. Consequently, a developer in the discharge section 4c can be efficiently discharged through the discharging port 4a having a small diameter (a diameter of approximately 2 mm).

### [Drive Receiving Mechanism]

A drive receiving mechanism (a drive input unit or a driving force receiving unit) of the developer supply container 1 will be described below. The drive receiving mechanism receives rotational driving force from the developer supply apparatus. The rotational driving force rotates the cylindrical portion 2k having the conveying protrusion 2c.

As illustrated in FIG. 6A, the developer supply container 1 includes a gear 2d that functions as a drive receiving mechanism (a drive input unit or a driving force receiving unit). The gear 2d can engage (be drive-linked) with the drive gear 300 (which functions as a driving mechanism) of the developer supply apparatus. The gear 2d can rotate simultaneously with the cylindrical portion 2k.

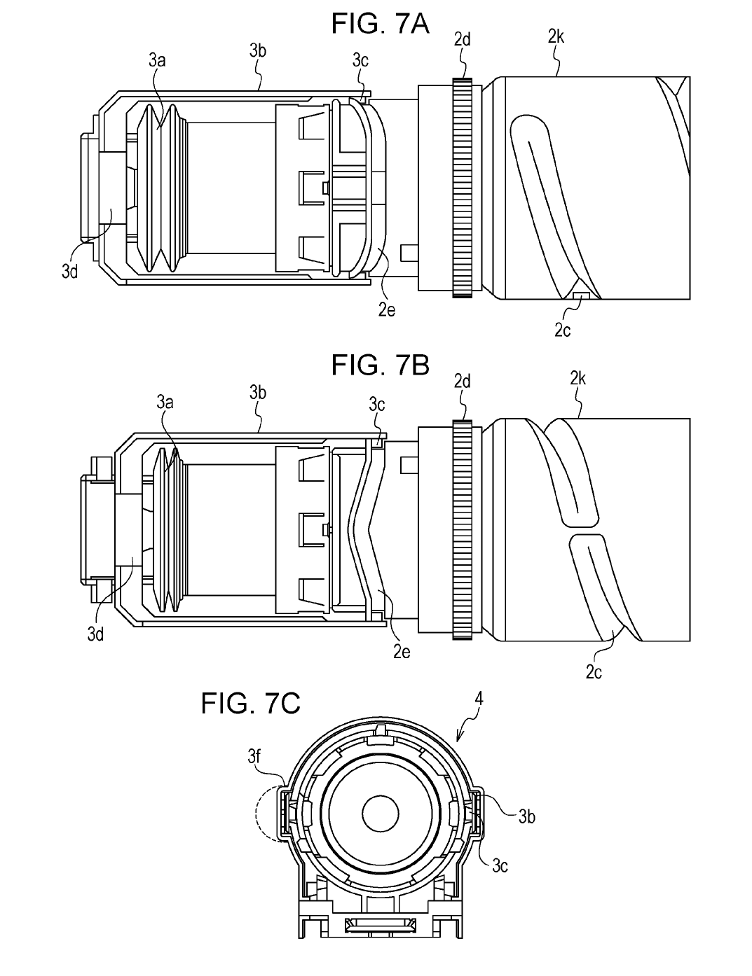

Thus, rotational driving force transmitted from the drive gear 300 to the gear 2d is transmitted to the pump unit 3a via a reciprocating member 3b illustrated in FIGS. 7A and 7B. It is more specifically described below in the section of the drive conversion mechanism. The bellows pump unit 3a in the present embodiment is made of a resin material that can withstand twists in the rotational direction without hindering expansion and contraction.

Although the gear 2d is disposed in the longitudinal direction of the cylindrical portion 2k (in the developer conveying direction) in the present embodiment, the gear 2d may be disposed at the other end, that is, at the rearmost end of the developer accommodation section 2 in the longitudinal direction. In this case, the drive gear 300 is disposed at the corresponding position.

Although the gear mechanism is used as a drive linkage mechanism between the drive input unit of the developer supply container 1 and the drive unit of the developer supply apparatus in the present embodiment, a coupling mechanism may be used. More specifically, the drive input unit may be a noncircular depressed portion, the drive unit of the developer supply apparatus may be a protruded portion corresponding to the depressed portion, and the depressed portion may be drive-linked with the protruded portion.

### [Drive Conversion Mechanism]

A drive conversion mechanism (drive conversion unit) of the developer supply container 1 will be described below.

In the present embodiment, a cam mechanism will be described below as an example of the drive conversion mechanism.

The developer supply container 1 is provided with a cam mechanism that functions as a drive conversion mechanism (drive conversion unit). The cam mechanism converts rotational driving force for rotating the cylindrical portion 2k received by the gear 2d into force in the direction of reciprocating movement of the pump unit 3a.

In the present embodiment, therefore, one drive input unit (the gear 2d) receives the driving force for the rotation of the cylindrical portion 2k and the driving force for the reciprocating movement of the pump unit 3a by converting the rotational driving force received by the gear 2d into the reciprocating force in the developer supply container 1.

This can simplify the drive input mechanism of the developer supply container 1, as compared with two independent drive input units in the developer supply container 1. Since the drive is transmitted from one drive gear of the developer supply apparatus, this can also simplify the driving mechanism of the developer supply apparatus.

FIG. 7A is a fragmentary view in which the pump unit 3a is fully expanded, FIG. 7B is a fragmentary view in which the pump unit 3a is fully contracted, and FIG. 7C is a fragmentary view of the pump unit 3a.

As illustrated in FIGS. 7A and 7B, the reciprocating member 3b converts the rotational driving force into the reciprocating force of the pump unit 3a. More specifically, a cam groove 2e in the entire perimeter of the developer supply container 1 rotates simultaneously with the drive input unit (gear 2d) for receiving rotation drive from the drive gear 300. The cam groove 2e will be described later. A reciprocating member engaging protrusion 3c on the reciprocating member 3b engages with the cam groove 2e.

In the present embodiment, as illustrated in FIG. 7C, a rotation restricting portion 3f prevents the reciprocating member 3b from rotating in the rotational direction of the cylindrical portion 2k (except backlash and play). Thus, the reciprocating member 3b is prevented from rotating in the rotational direction and reciprocates along the cam groove 2e (in the X direction and in the opposite direction in FIG. 6B). A plurality of reciprocating member engaging protrusions 3c engage with the cam groove 2e. More specifically, two opposite reciprocating member engaging protrusions 3c are disposed on the periphery of the cylindrical portion 2k.

The number of reciprocating member engaging protrusions 3c may be at least one. Drag resulting from the expansion and contraction of the pump unit 3a may produce a moment in the drive conversion mechanism and hinder smooth reciprocating movements. Thus, a plurality of reciprocating member engaging protrusions 3c can be provided in order to maintain the engagement with the cam groove 2e, as described below.

The rotational driving force transmitted from the drive gear 300 rotates the cam groove 2e, and a reciprocating member engaging protrusion 3c reciprocates in the X direction and in the opposite direction along the cam groove 2e. The pump unit 3a is alternately expanded (FIG. 7A) and contracted (FIG. 7B). Thus, the volume of the developer supply container 1 is changed.

### [Setting Conditions for Drive Conversion Mechanism]

In the present embodiment, the drive conversion mechanism performs drive conversion such that the amount of developer (per unit time) conveyed to the discharge section 4c by the rotation of the cylindrical portion 2k is greater than the amount of developer (per unit time) discharged by pumping from the discharge section 4c into the developer supply apparatus.

This is because the developer discharge capacity of the pump unit 3a higher than the capacity of the conveying protrusion 2c to convey a developer to the discharge section 4c results in a gradual decrease in the amount of developer in the discharge section 4c. In other words, this is in order to suppress an increase in the time of developer supply from the developer supply container 1 to the developer supply apparatus.

In the present embodiment, the drive conversion mechanism performs drive conversion such that the pump unit 3a reciprocates multiple times per rotation of the cylindrical portion 2k. This is due to the following reason.

For the rotation of the cylindrical portion 2k in the developer supply apparatus, the drive motor 500 can have an output that allows the cylindrical portion 2k to rotate stably. In order to minimize the energy consumption of the main body 100 of the image-forming apparatus, however, the output of the drive motor 500 can be minimized. The required output of the drive motor 500 is calculated from the rotation torque and the number of rotation of the cylindrical portion 2k. Thus, the number of rotation of the cylindrical portion 2k can be minimized to decrease the output of the drive motor 500.

In the present embodiment, however, a decreased number of rotation of the cylindrical portion 2k results in a decreased number of movements of the pump unit 3a per unit time and consequently a decreased amount of developer discharged from the developer supply container 1 (per unit time). Thus, the amount of developer discharged from the developer supply container 1 may be insufficient to meet the demand of the main body 100 of the image-forming apparatus in a short time.

Although the volume change of the pump unit 3a may be increased to increase the developer discharge amount per stroke of the pump unit 3a and meet the demand of the main body 100 of the image-forming apparatus, this method causes the following problem.

An increased volume change of the pump unit 3a results in an increased peak value of the internal pressure (positive pressure) of the developer supply container 1 in the exhaust step, which results in an increased load required for the reciprocating movement of the pump unit 3a.

For this reason, in the present embodiment, the pump unit 3a reciprocates multiple times per rotation of the cylindrical portion 2k. This can increase the developer discharge amount per unit time without increasing the volume change of the pump unit 3a, as compared with the case where the pump unit 3a reciprocates once per rotation of the cylindrical portion 2k. The number of rotation of the cylindrical portion 2k can be decreased by increasing the developer discharge amount.

Thus, in the present embodiment, the output of the drive motor 500 can be decreased. This can decrease the energy consumption of the main body 100 of the image-forming apparatus.

### [Position of Drive Conversion Mechanism]

In the present embodiment, as illustrated in FIGS. 7A to 7C, the drive conversion mechanism (the cam mechanism composed of the reciprocating member engaging protrusions 3c and the cam groove 2e) is disposed on the outside of the developer accommodation section 2. More specifically, the drive conversion mechanism is separated from the internal spaces of the cylindrical portion 2k, the pump unit 3a, and the discharge section 4c so that the drive conversion mechanism does not come into contact with a developer in the cylindrical portion 2k, the pump unit 3a, and the discharge section 4c.

Thus, problems associated with the drive conversion mechanism in the internal space of the developer accommodation section 2 can be avoided. More specifically, the isolation of the drive conversion mechanism can prevent developer particles (toner base particles) from entering a friction site of the drive conversion mechanism, from being softened by heat and pressure, and from coalescing into blocks (coarse particles). This can also prevent a developer from being pinched in the drive conversion mechanism and thereby increasing torque.

The step of supplying a developer from the developer supply container 1 to the developer supply apparatus will be described below.

### [Developer Supply Step]

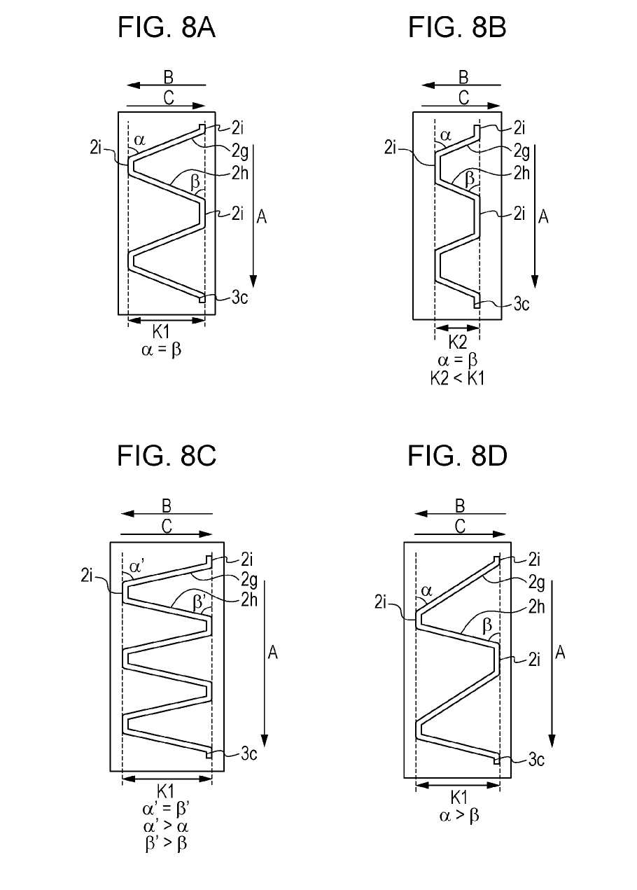

The step of supplying a developer using the pump unit 3a will be described below with reference to FIGS. 7A to 7C and FIGS. 8A to 8F.

FIGS. 8A to 8F are development views of the cam groove 2e in the drive conversion mechanism (the cam mechanism composed of a reciprocating member engaging protrusion 3c and the cam groove 2e).

As described below, the present embodiment includes an intake step (intake operation through the discharging port 4a) and an exhaust step (exhaust operation through the discharging port 4a) by the operation of the pump unit and a suspended step (no intake or exhaust through the discharging port 4a) of stopping the operation of the pump unit. The drive conversion mechanism converts rotational driving force into reciprocating force.

The intake step, exhaust step, and suspended step will be described below.

### [Intake Step]

First, the intake step (intake operation through the discharging port 4a) will be described below.

In the intake operation, the fully contracted state of the pump unit 3a (FIG. 7B) is changed to the fully expanded state of the pump unit 3a (FIG. 7A) by the drive conversion mechanism (cam mechanism). The intake operation increases the volume of the developer accommodation section of the developer supply container 1 (the pump unit 3a, the cylindrical portion 2k, and the discharge section 4c).

The developer supply container 1 is substantially hermetically sealed except the discharging port 4a. The discharging port 4a is substantially blocked with a developer T. Thus, the internal pressure of the developer supply container 1 decreases with increasing volume of the section of the developer supply container 1 that can store the developer T.

In this case, the internal pressure of the developer supply container 1 is lower than the atmospheric pressure (outside air pressure). Thus, outside air enters the developer supply container 1 through the discharging port 4a due to a pressure difference between the inside and outside of the developer supply container 1.

Air entering the developer supply container 1 through the discharging port 4a can loosen (fluidize) the developer T in the vicinity of the discharging port 4a. More specifically, air can decrease the bulk density of the developer T in the vicinity of the discharging port 4a and thereby fluidize the developer T.

Because air enters the developer supply container 1 through the discharging port 4a, the internal pressure of the developer supply container 1 is close to the atmospheric pressure (outside air pressure) irrespective of the increased volume.

Since the developer T is fluidized, the developer T does not block the discharging port 4a and can be smoothly discharged through the discharging port 4a in the exhaust operation described below. Thus, the amount of developer T discharged through the discharging port 4a (per unit time) can be substantially constant for extended periods.

In the intake operation, the fully contracted state of the pump unit 3a is not necessarily changed to the fully expanded state of the pump unit 3a. Even when the pump unit 3a stops before reaching the fully expanded state, the intake operation can be performed by any change in the internal pressure of the developer supply container 1. In other words, the intake step refers to the state in which the reciprocating member engaging protrusion 3c engages with a cam groove 2h in FIG. 8A.

### [Exhaust Step]

The exhaust step (exhaust operation through the discharging port 4a) will be described below.

In the exhaust operation, the fully expanded state of the pump unit 3a (FIG. 7A) is changed to the fully contracted state of the pump unit 3a (FIG. 7B). More specifically, the exhaust operation decreases the volume of the developer accommodation section of the developer supply container 1 (the pump unit 3a, the cylindrical portion 2k, and the discharge section 4c). The developer supply container 1 is substantially hermetically sealed except the discharging port 4a. The discharging port 4a is substantially blocked with a developer T until the developer T is discharged. Thus, the internal pressure of the developer supply container 1 increases with decreasing volume of the developer accommodation section of the developer supply container 1.

The internal pressure of the developer supply container 1 becomes higher than the atmospheric pressure (outside air pressure), and the developer T is discharged through the discharging port 4a due to a pressure difference between the inside and outside of the developer supply container 1. Thus, the developer T is discharged from the developer supply container 1 into the developer supply apparatus.

Together with the developer T, air in the developer supply container 1 is also discharged, and the internal pressure of the developer supply container 1 decreases.

In the present embodiment, as described above, the developer can be efficiently discharged by one reciprocating pump unit 3a, and the mechanism for discharging the developer can be simplified.

In the exhaust operation, the fully expanded state of the pump unit 3a is not necessarily changed to the fully contracted state of the pump unit 3a. Even when the pump unit 3a stops before reaching the fully contracted state, the exhaust operation can be performed by any change in the internal pressure of the developer supply container 1. In other words, the exhaust step refers to the state in which the reciprocating member engaging protrusion 3c engages with a cam groove 2g in FIG. 8A.

### [Suspended Step]

The suspended step, in which the pump unit 3a does not reciprocate, will be described below.

In the present embodiment, as described above, the controller 600 controls the operation of the drive motor 500 on the basis of the detection results of the magnetic sensor 800c or the developer sensor 10d. Because the amount of developer discharged from the developer supply container 1 directly influences the toner concentration, the amount of developer required for the image-forming apparatus must be supplied from the developer supply container 1. In order to stabilize the amount of developer discharged from the developer supply container, the volume change can be fixed.

For example, when the cam groove 2e is composed of the exhaust step and the intake step, the motor drive is stopped during the exhaust step or the intake step. However, even after the drive motor 500 is stopped, the cylindrical portion 2k rotates by inertia, and the pump unit 3a also reciprocates simultaneously with the cylindrical portion 2k, thus performing the exhaust step or intake step. The rotational distance of the cylindrical portion 2k by inertia depends on the rotational speed of the cylindrical portion 2k. The rotational speed of the cylindrical portion 2k depends on the torque applied to the drive motor 500. The torque applied to the drive motor 500 may vary with the amount of developer in the developer supply container 1, and accordingly the rotational speed of the cylindrical portion 2k may also vary. It is therefore difficult to stop the pump unit 3a at the same position each time.

In order to stop the pump unit 3a at the same position each time, the cam groove 2e needs a region in which the pump unit 3a does not reciprocate regardless of the rotation of the cylindrical portion 2k. In the present embodiment, a cam groove 2i illustrated in FIG. 8A is provided to stop the pump unit 3a. The cam groove 2i is formed in the rotational direction of the cylindrical portion 2k and has a straight shape such that the reciprocating member 3b does not reciprocate regardless of the rotation of the cylindrical portion 2k. Thus, the suspended step refers to the state in which the reciprocating member engaging protrusion 3c engages with the cam groove 2i.

No reciprocating movement of the pump unit 3a refers to no discharge of a developer through the discharging port 4a (except a developer falling through the discharging port 4a due to vibrations resulting from the rotation of the cylindrical portion 2k). Thus, provided that no exhaust step or intake step through the discharging port 4a is performed, the cam groove 2i may be inclined in the rotation axis direction relative to the rotational direction. In the case that the cam groove 2i is inclined, the pump unit 3a may reciprocate correspondingly.

### Other Examples of Setting Conditions for Cam Grooves

Other examples of the setting conditions for the cam groove 2e will be described below with reference to FIG. 8A. Referring to the development view of the drive conversion mechanism in FIG. 8A, the effects of the shape of the cam groove 2e on the operating conditions for the pump unit 3a will be described below.

In FIG. 8A, the arrow A indicates the rotational direction of the cylindrical portion 2k (the movement direction of the cam groove 2e), the arrow B indicates the expansion direction of the pump unit 3a, and the arrow C indicates the contraction direction of the pump unit 3a. The cam groove 2e is composed of the cam groove 2g for contracting the pump unit 3a, the cam groove 2h for expanding the pump unit 3a, and a pump unit non-operating portion 2i for stopping the pump unit 3a. The cam groove 2g forms an angle α with the rotational direction A of the cylindrical portion 2k. The cam groove 2h forms an angle β with the rotational direction A. The cam grooves have an amplitude K1 (=the expansion and contraction length of the pump unit 3a) in the expansion and contraction directions B and C of the pump unit 3a.

The expansion and contraction length K1 of the pump unit 3a will be described below.

For example, a short expansion and contraction length K1 results in a small volume change of the pump unit 3a and a small pressure difference from the outside air pressure. This decreases pressure applied to a developer in the developer supply container 1 and the amount of developer discharged from the developer supply container 1 per stroke of the pump unit 3a (=one expansion and contraction stroke of the pump unit 3a).

As illustrated in FIG. 8B, if the cam grooves have the constant angles α and β and an amplitude K2 smaller than K1, the developer discharge amount per stroke of the pump unit 3a can be smaller than that of the structure illustrated in FIG. 8A. Conversely, when the cam grooves have an amplitude K2 greater than K1, the developer discharge amount can be increased.

When the angles α and β of the cam grooves are increased, and the rotational speed of the cylindrical portion 2k is constant, this increases the moving distance of the reciprocating member engaging protrusion 3c during the rotation of the developer accommodation section 2 for a predetermined period. This results in an increased expansion and contraction speed of the pump unit 3a.

This increases the resistance of the cam grooves 2g and 2h to the movement of the reciprocating member engaging protrusion 3c. The increased resistance results in high rotation torque of the cylindrical portion 2k.

Thus, as illustrated in FIG. 8C, if the expansion and contraction length K1 is constant, the cam groove 2g has an angle α′ greater than α, and the cam groove 2h has an angle β′ greater than beta, then the expansion and contraction speed is higher than that of the structure illustrated in FIG. 8A. This increases the number of expansion and contraction strokes of the pump unit 3a per rotation of the cylindrical portion 2k. This also increases the flow velocity of air entering the developer supply container 1 through the discharging port 4a and facilitates loosening of a developer in the vicinity of the discharging port 4a.

Conversely, if the cam groove 2g has an angle α′ smaller than α, and the cam groove 2h has an angle β′ smaller than beta, then the rotation torque of the cylindrical portion 2k can be decreased. When a fluent developer is used, the developer in the vicinity of the discharging port 4a can be easily blown by air passing through the discharging port 4a during expansion of the pump unit 3a. Consequently, the developer cannot be sufficiently stored in the discharge section 4c, and the developer discharge amount can be decreased. In such a case, the expansion speed of the pump unit 3a can be decreased as described above to suppress blowing of the developer and improve discharge capacity.

As in the cam groove 2e illustrated in FIG. 8D, angle α<angle β can result in a higher expansion speed than the contraction speed of the pump unit 3a. Conversely, angle α>angle β can result in a lower expansion speed than the contraction speed of the pump unit 3a.

Thus, when a developer in the developer supply container 1 has a high density, the operation force of the pump unit 3a is greater during contraction of the pump unit 3a than during expansion of the pump unit 3a. Consequently, the rotation torque of the cylindrical portion 2k tends to be higher during contraction of the pump unit 3a.

In this case, however, the cam groove 2e illustrated in FIG. 8D can facilitate loosening of a developer during expansion of the pump unit 3a, as compared with the cam groove 2e illustrated in FIG. 8A. This can also decrease the resistance of the cam groove 2e to the movement of the reciprocating member engaging protrusion 3c during contraction of the pump unit 3a and suppress an increase in rotation torque during contraction of the pump unit 3a.

As illustrated in FIG. 8E, the cam groove 2e may be provided such that the reciprocating member engaging protrusion 3c passes through the cam groove 2g immediately after the reciprocating member engaging protrusion 3c passes through the cam groove 2h. In this case, the intake operation of the pump unit 3a is directly followed by the exhaust operation of the pump unit 3a. Because the suspended step in FIG. 8A during which the pump unit 3a maintains the expanded state is omitted, the low-pressure state of the developer supply container 1 is interrupted, and the effect of loosening the developer T is reduced. However, without the suspended step, the number of intake and exhaust steps per rotation of the cylindrical portion 2k can be increased, and the discharge amount of developer T can be increased.

As illustrated in FIG. 8F, in addition to the fully contracted state of the pump unit 3a or the fully expanded state of the pump unit 3a, the suspended step can be performed during the exhaust step and the intake step. This allows the volume change to be adjusted as required and the internal pressure of the developer supply container 1 to be adjusted.

Thus, the discharge capacity of the developer supply container 1 can be adjusted by selecting the shape of the cam groove 2e as illustrated in FIGS. 8A to 8F, thereby satisfying the amount of developer and the physical properties of the developer required for the developer supply apparatus.

In the present embodiment, as described above, one drive input unit (the gear 2d) receives both the driving force for rotating the cylindrical portion 2k having the conveying protrusion (spiral protruded portion 2c) and the driving force for reciprocating the pump unit 3a. This can simplify the drive input mechanism of the developer supply container. Furthermore, driving force is applied to the developer supply container using one driving mechanism (the drive gear 300) of the developer supply apparatus. This can also simplify the driving mechanism of the developer supply apparatus.

In the present embodiment, the rotational driving force for rotating the cylindrical portion 2k received from the developer supply apparatus is drive-converted by the drive conversion mechanism of the developer supply container. Thus, the pump unit 3a can be properly reciprocated.

### (Suppression Part)

The suppression part 7, which is the most characteristic component according to an aspect of the present invention, will be more specifically described below with reference to FIGS. 6A to 6C and FIGS. 9A and 9B to FIG. 11.

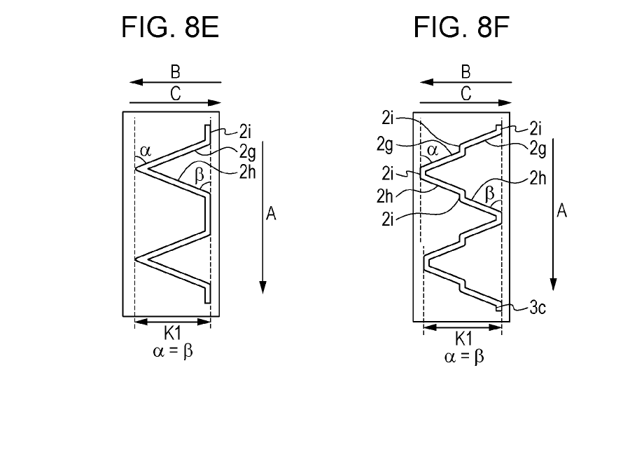

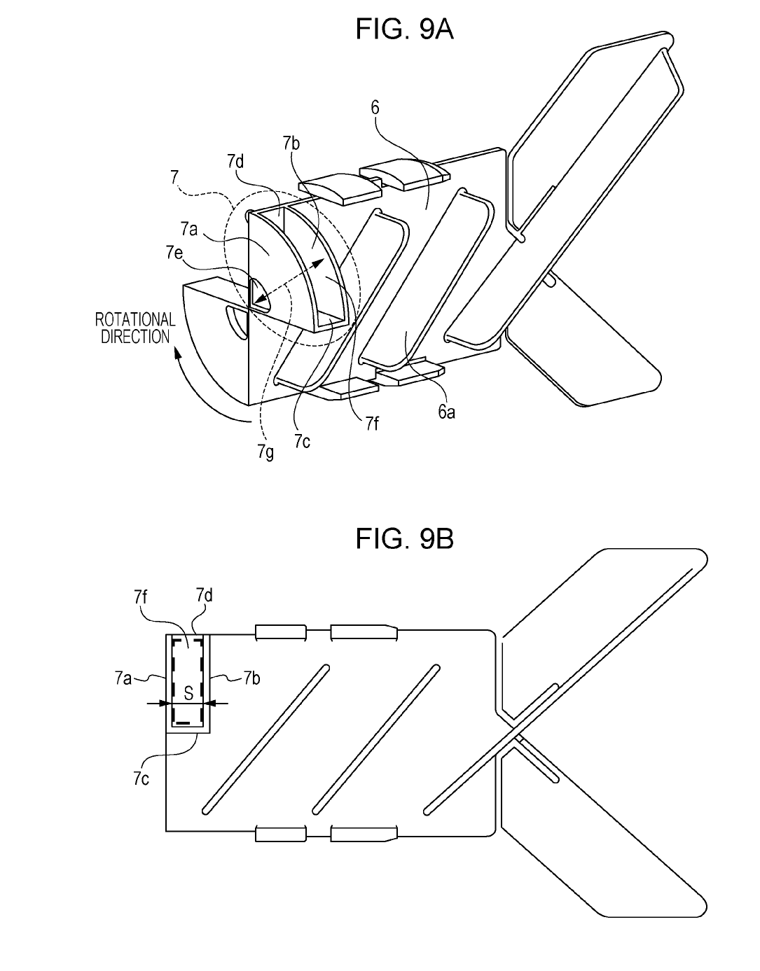

FIG. 6A is a cross-sectional perspective view of the developer supply container, FIG. 6B is a fragmentary sectional view in which the pump unit is fully expanded, and FIG. 6C is a fragmentary sectional view in which the pump unit is fully contracted. FIG. 9A is an overall perspective view of a conveying member 6 to be installed in a container described in Example 1, and FIG. 9B is a side view of the conveying member 6. FIGS. 10A to 10D are cross-sectional views of a container during supply operation as viewed from the pump unit 3a side in FIGS. 6A to 6C. FIG. 10A is a cross-sectional view of a discharge section while the pump unit is stopped, FIG. 10B is a cross-sectional view of the discharge section during intake, FIG. 10C is a cross-sectional view of the discharge section during exhaustion, and FIG. 10D is a cross-sectional view of the discharge section after a developer is discharged.

As illustrated in FIG. 6A, the suppression part 7 is integrally disposed at an end of the conveying member 6 on the pump unit 3a side. Thus, as the conveying member 6 rotates simultaneously with the cylindrical portion 2k, the suppression part 7 also rotates simultaneously therewith.

As illustrated in FIGS. 9A and 9B, the suppression part 7 is composed of two thrust suppression walls 7a and 7b and two radial suppression walls 7c and 7d. The thrust suppression walls 7a and 7b are separated by the width S in the rotation axis direction. The radial suppression walls 7c and 7d are disposed in the rotational direction. An accommodation section opening 7e is disposed near the axis of rotation of the thrust suppression wall 7a disposed closer to the pump unit 3a. The internal space of the developer accommodation section 2 can communicate with the internal space of the suppression part 7 through the accommodation section opening 7e. A storage section opening 7f is surrounded by the outer ends of the two thrust suppression walls 7a and 7b and the two radial suppression walls 7c and 7d distant from the axis of rotation. The storage section opening 7f can communicate with the developer storage section 4d. The position of the storage section opening 7f along the axis of rotation in the thrust direction at least partly overlaps the position of the developer storage section 4d. The suppression part 7 surrounded by the two thrust suppression walls 7a and 7b and the two radial suppression walls 7c and 7d includes a communication path 7g, which can communicate with the accommodation section opening 7e and the storage section opening 7f.

The operation of the suppression part 7 in the developer supply step will be described below with reference to FIGS. 10A to 10D.

FIG. 10A illustrates the suspended step, in which the pump unit 3a is stopped while the cylindrical portion 2k rotates in the developer supply container 1.

The suppression part 7 rotates simultaneously with the conveying member 6. The storage section opening 7f of the suppression part 7 does not overlap the top of the developer storage section 4d disposed at the bottom of the discharge section 4c. In the suspended step, the pump unit 3a does not reciprocate, and the internal pressure of the developer accommodation section 2 is constant.

Consequently, the suppression part 7 does not operate on the developer storage section 4d. A developer T in the vicinity of the top of the developer storage section 4d conveyed by the conveying member 6 (a developer before discharge) flows into the developer storage section 4d and is stored (an unsuppressed developer inflow state).

As the conveying member 6 rotates, the state in FIG. 10A changes to the state in FIG. 10B.

FIG. 10B illustrates the intake step, in which the fully contracted state of the pump unit 3a changes to the fully expanded state.

The suppression part 7 rotates simultaneously with the conveying member 6. The storage section opening 7f of the suppression part 7 that did not overlap the top of the developer storage section 4d partly overlaps the top of the developer storage section 4d. In the intake step, the pump unit 3a is expanded, and the developer accommodation section 2 has a reduced pressure. Owing to a pressure difference between the inside and outside of the developer supply container 1, air enters the developer supply container 1 through the discharging port 4a.

Consequently, the developer T stored in the developer storage section 4d contains the air, has a decreased bulk density, and is fluidized.

As the suppression part 7 rotates, the storage section opening 7f of the suppression part 7 overlaps the top of the developer storage section 4d, and the radial suppression wall 7c of the suppression part 7 on the downstream side in the rotational direction pushes away the developer T at the top of the developer storage section 4d. The storage section opening 7f of the suppression part 7 partly overlaps the top of the developer storage section 4d. Consequently, the thrust suppression walls 7a and 7b and the radial suppression walls 7c and 7d of the suppression part 7 suppress the inflow of the developer T in the vicinity of the top of the developer storage section 4d into the developer storage section 4d (a suppressed developer inflow state).

As the conveying member 6 further rotates, the state in FIG. 10B changes to the state in FIG. 10C.

FIG. 10C illustrates the exhaust step, in which the fully expanded state of the pump unit 3a changes to the fully contracted state.

The suppression part 7 rotates simultaneously with the conveying member 6. At least part of the storage section opening 7f of the suppression part 7 always overlaps the top of the developer storage section 4d. In the exhaust step, the pump unit 3a is contracted, and the internal pressure of the developer supply container 1 becomes higher than the atmospheric pressure. Thus, air in the developer supply container 1 is exhausted through the discharging port 4a due to a pressure difference between the inside and outside of the developer supply container 1.

Consequently, the developer T in the developer storage section 4d fluidized in the intake step is discharged into the developer supply apparatus through the discharging port 4a.

Also in this exhaust step, as the suppression part 7 rotates, the radial suppression wall 7c of the suppression part 7 on the downstream side in the rotational direction pushes away the toner at the top of the developer storage section 4d as in the intake step. At least part of the storage section opening 7f of the suppression part 7 always overlaps the top of the developer storage section 4d. Consequently, in the exhaust step, the thrust suppression walls 7a and 7b and the radial suppression walls 7c and 7d of the suppression part 7 always suppress the inflow of the developer T in the vicinity of the top of the developer storage section 4d into the developer storage section 4d (a suppressed developer inflow state).

An air flow in the developer supply container 1 that acts on the developer T in the developer storage section 4d in the exhaust step will be more specifically described.

There are two air flows that act on the developer T in the developer storage section 4d in the exhaust step.

One air flow from the developer accommodation section 2 passes through

the accommodation section opening 7e near the axis of rotation of the suppression part 7,
the communication path 7g in the suppression part 7, and
the storage section opening 7f of the suppression part 7 in communication with the developer storage section 4d, and acts on the developer T in the developer storage section 4d.

The other air flow passes through a space between the top of the developer storage section 4d and the suppression part 7 on the top of the developer storage section 4d and acts on the developer T in the developer storage section 4d.

However, for the following reason, the air flow that acts on the developer T in the developer storage section 4d in the exhaust step is mainly the former air flow.

In the exhaust step, the thrust suppression walls 7a and 7b and the radial suppression walls 7c and 7d of the suppression part 7 suppress the inflow of the developer T in the vicinity of the periphery of the storage section opening 7f of the suppression part 7 overlapping the top of the developer storage section 4d into the developer storage section 4d. Thus, the developer T remains in the vicinity of the periphery of the storage section opening 7f of the suppression part 7 and acts as a resistance to the air flowing into the developer storage section 4d. In the exhaust step, the vicinity of the accommodation section opening 7e near the axis of rotation of the suppression part 7 is disposed above the storage section opening 7f in the vertical direction. Thus, the residual developer T is less in the vicinity of the accommodation section opening 7e than in the vicinity of the storage section opening 7f, and resistance to the air flow is smaller in the vicinity of the accommodation section opening 7e. Owing to the smaller resistance of the developer T to the air flow, the main air flow in the exhaust step is the air flow passing through the communication path 7g in the suppression part 7.

Thus, in the exhaust step, the developer T in the developer storage section 4d in communication with the communication path 7g of the suppression part 7 is discharged into the developer supply apparatus by the air flow passing through the communication path 7g. As described above, in the exhaust step, the developer storage section 4d has the suppressed developer inflow state in which the suppression part 7 always suppresses the inflow of the developer T, and a substantially constant amount of developer is stored in the developer storage section 4d.

When the developer T in the developer storage section 4d is discharged by the air flow, the inside space of the developer supply container 1 communicates with the outside. After that, only air is released, and the internal pressure of the developer supply container 1 in the exhaust step becomes equivalent to the external pressure of the developer supply container 1. In other words, after the developer T in the developer storage section 4d is discharged, only air is released due to a pressure difference between the inside and outside of the developer supply container 1, and the developer T is not discharged. Thus, in the exhaust step, only a certain amount of developer T stored in the developer storage section 4d is discharged, and the developer T is discharged into the developer supply apparatus with very high supply accuracy.

In the exhaust step, the storage section opening 7f of the suppression part 7 can completely overlap the top of the developer storage section 4d. This prevents the developer T in the vicinity of the top of the developer storage section 4d from entering the developer storage section 4d in the exhaust step, thus achieving more consistent supply accuracy.

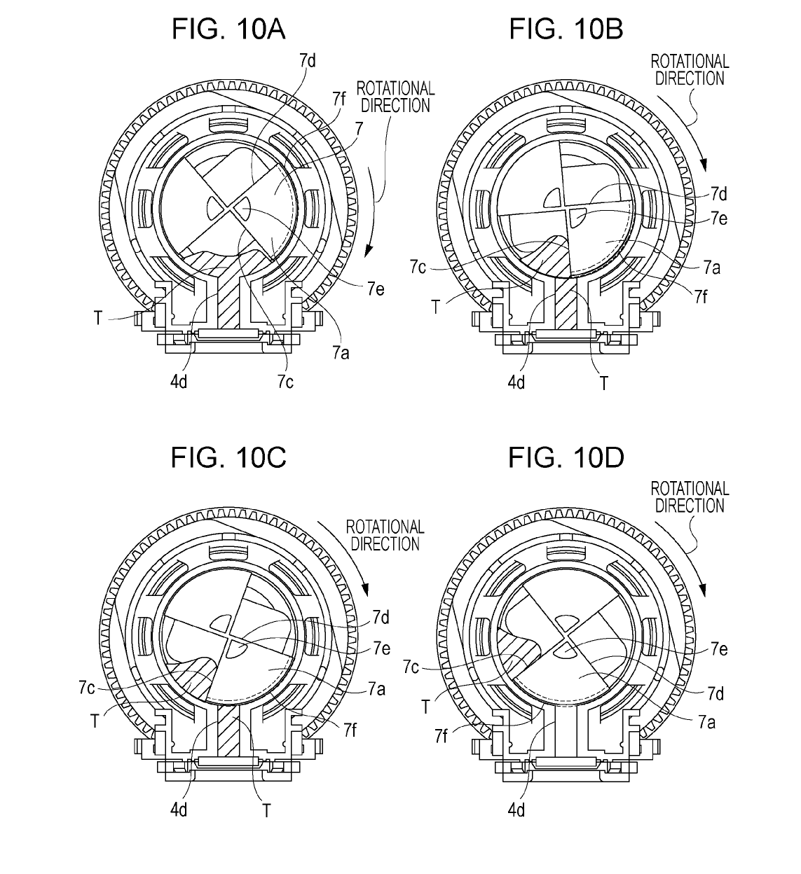

A structure having no suppression part 7 will be described below as a conventional art with reference to FIG. 11.

FIG. 11 is a cross-sectional perspective view of an existing developer supply container. The structure in FIG. 11 is the same as the structure according to the present embodiment except the suppression part 7.

As illustrated in FIG. 11, in the structure according to the conventional art, the suppression part 7 is not disposed on the top of the developer storage section 4d, and the developer storage section 4d is always opened. The developer T can enter the developer storage section 4d without restriction. Thus, in the exhaust step, in addition to a certain amount of developer T stored in the developer storage section 4d, an uncontrollable amount of developer T in the vicinity of the top of the developer storage section 4d is also discharged. The uncontrollable amount of developer refers to the developer T mainly in the vicinity of the top of the developer storage section 4d influenced by the uncontrolled powder surface of the developer in the developer supply container 1. The uncontrolled powder surface of the developer in the vicinity of the top of the developer storage section 4d may be high or low, and the amount of developer entering the developer storage section 4d in the exhaust step is uncontrollably variable. Thus, in the conventional art, an uncontrollable amount of developer T in the vicinity of the top of the developer storage section 4d is discharged in the exhaust step.

In the conventional art, the top of the developer storage section 4d is opened in the exhaust step. Thus, the developer T is continuously disposed at the top of the discharging port 4a. Owing to a pressure difference between the inside and outside of the developer supply container 1, the developer T is continuously discharged by an air flow until the internal pressure of the developer supply container 1 substantially reaches the atmospheric pressure.

Thus, in the conventional art, an uncontrollable amount of developer in the vicinity of the top of the developer storage section 4d is continuously discharged in the exhaust step. Thus, it is difficult to achieve the supply accuracy of the present embodiment.

In contrast, in the present embodiment, the radial suppression wall 7c of the suppression part 7 on the downstream side in the rotational direction pushes away the developer T in the vicinity of the top of the developer storage section 4d, and the powder surface of the developer is leveled off. Thus, the powder surface of the developer in the developer storage section 4d is kept constant. The suppression part 7 covering the developer storage section 4d prevents the developer T from entering the developer storage section 4d and maintains the constant powder surface of the developer in the developer storage section 4d. In the exhaust step, as described above, after the developer T in the developer storage section 4d is discharged, the inside space of the developer supply container 1 communicates with the outside, and only air is released. This prevents the developer T from being continuously discharged due to a pressure difference between the inside and outside of the developer supply container 1.

Thus, in the structure including the suppression part 7, a certain amount of developer T always stored in the developer storage section 4d can be discharged into the developer supply apparatus in the exhaust step, and the developer T can be discharged with very consistent supply accuracy.

FIG. 10D is a cross-sectional view of the discharge section after a developer in the developer storage section 4d is discharged. Except the developer on the surface of the walls, the developer storage section 4d contains no developer T. As the conveying member 6 further rotates, the discharge section returned to the state illustrated in FIG. 10A, and the same steps are repeatedly performed. Thus, the structure according to the present embodiment can always discharge the developer T with consistent supply accuracy from the beginning to the end of discharge. The suppression part 7 is very effective for high supply accuracy.

Although two suppression parts 7 are disposed on the conveying member 6 in the present embodiment, aspects of the present invention are not limited to this structure. The present cam structure includes two exhaust steps while the cylindrical portion 2k rotates 360 degrees and needs two suppression parts 7. For example, for three exhaust steps while the cylindrical portion 2k rotates 360 degrees, three suppression parts 7 may be provided.

As described above, the suppression part 7 is disposed on the conveying member 6. As the conveying member 6 rotates simultaneously with the cylindrical portion 2k, the suppression part 7 also rotates simultaneously therewith. In the present embodiment, as described above, one drive input unit (the gear 2d) receives both the driving force for rotating the cylindrical portion 2k and the driving force for reciprocating the pump unit 3a. One drive input unit (the gear 2d) also receives the driving force for rotating the suppression part 7 together with the driving force for rotating the cylindrical portion 2k. Thus, the structure according to the present embodiment requires three driving forces for rotation of the cylindrical portion 2k, reciprocating movement of the pump unit 3a, and rotation of the suppression part 7, and one drive input unit (the gear 2d) receives the three driving forces.

This can significantly simplify the drive input mechanism of the developer supply container 1, as compared with three independent drive input units in the developer supply container 1. One driving mechanism (the drive gear 300) of the developer supply apparatus can significantly simplify the driving mechanism of the developer supply apparatus.

Two drives for discharging the developer T, that is, the reciprocating movement of the pump unit 3a and the rotation of the suppression part 7 are linked to the rotation of the cylindrical portion 2k. Thus, it is very easy to time the right moment to drive the pump unit 3a and the suppression part 7.

Aspects of the present invention will be more specifically described in the following examples. However, aspects of the present invention are not limited to these examples.

### Production Examples of Developer

### Production Example of Binder Resin 1

Polyoxypropylene(2.2)-2,2-bis(4-hydroxyphenyl)propane 76.9 parts by mass (0.167 molar parts)
Terephthalic acid 24.1 parts by mass (0.145 molar parts)
Titanium tetrabutoxide 0.5 parts by mass

A 4-L four-neck glass flask was charged with these materials. A thermometer, a stirring rod, a condenser, and a nitrogen inlet were attached to the flask. The flask was placed in a mantle heater.

After the flask was purged with a nitrogen gas, the materials were gradually heated while stirring and were allowed to react at 200° C. for 4 hours while stirring (a first reaction step). Then, 2.0 parts by mass (0.010 molar parts) of trimellitic anhydride was added to the product and was allowed to react at 180° C. for 1 hour (a second reaction step), thus yielding a binder resin 1.

The binder resin 1 had an acid value of 10 mgKOH/g and a hydroxyl value of 65 mgKOH/g. The binder resin 1 had a weight-average molecular weight (Mw) of 8,000, a number-average molecular weight (Mn) of 3,500, and a peak molecular weight (Mp) of 5,700, as measured by GPC. The binder resin 1 had a softening point of 90° C.

### Production Example of Binder Resin 2

Polyoxypropylene(2.2)-2,2-bis(4-hydroxyphenyl)propane 71.3 parts by mass (0.155 molar parts)
Terephthalic acid 24.1 parts by mass (0.145 molar parts)
Titanium tetrabutoxide 0.6 parts by mass

A 4-L four-neck glass flask was charged with these materials. A thermometer, a stirring rod, a condenser, and a nitrogen inlet were attached to the flask. The flask was placed in a mantle heater.

After the flask was purged with a nitrogen gas, the materials were gradually heated while stirring and were allowed to react at 200° C. for 2 hours while stirring (a first reaction step). Then, 5.8 parts by mass (0.030% by mole) of trimellitic anhydride was added to the product and was allowed to react at 180° C. for 10 hours (a second reaction step), thus yielding a binder resin 2.

The binder resin 2 had an acid value of 15 mgKOH/g and a hydroxyl value of 7 mgKOH/g. The binder resin 2 had a weight-average molecular weight (Mw) of 200,000, a number-average molecular weight (Mn) of 5,000, and a peak molecular weight (Mp) of 10,000, as measured by GPC. The binder resin 2 had a softening point of 130° C.

### Production Example 1 of Polymer A

Low-density polyethylene (Mw: 1400, Mn: 850, maximum endothermic peak by DSC: 100° C.) 18.0 parts by mass
Styrene 66.0 parts by mass
n-Butyl acrylate 13.5 parts by mass
Acrylonitrile 2.5 parts by mass

An autoclave was charged with the materials, was purged with N₂, and was held at 180° C. while stirring. 50 parts by mass of a xylene solution of 2% by mass t-butyl hydroperoxide was added dropwise for 5 hours. After cooling, the solvent was removed. A polymer A was produced by a reaction between the low-density polyethylene and the vinyl resin components.

The polymer A had a weight-average molecular weight (Mw) of 7,100 and a number-average molecular weight (Mn) of 3,000. Transmittance for a dispersion liquid of the polymer A dispersed in 45% by volume aqueous methanol was 69% at a wavelength of 600 nm at 25° C.

### Production Example of Toner 1

Binder resin 1 50.0 parts by mass
Binder resin 2 50.0 parts by mass
Fischer-Tropsch wax (peak temperature of maximum endothermic peak: 78° C.) 5.0 parts by mass
C.I. Pigment Blue 15:3 5.0 parts by mass
Aluminum 3,5-di-t-butyl salicylate compound 0.5 parts by mass
Polymer A 6.0 parts by mass

The materials were mixed in a Henschel mixer (FM-75, manufactured by Mitsui Mining Co., Ltd.) at a rotational speed of 20 s⁻¹ for 5 minutes. The materials were then mixed in a twin-screw kneader (PCM-30, manufactured by Ikegai Corporation) at 125° C. The mixture was cooled and was roughly crushed to 1 mm or less using a hammer mill. The roughly crushed mixture was pulverized in a mechanical grinder (T-250, manufactured by Freund-Turbo Corporation). Classification using a centrifugal force classifier (200TSP, manufactured by Hosokawa Micron Corporation) yielded toner base particles. The number of rotation of rotors in the centrifugal force classifier (200TSP, manufactured by Hosokawa Micron Corporation) was 50.0 s⁻¹.

The toner base particles had a weight-average particle diameter (D4) of 6.3 μm.

The toner base particles were heat-treated in the surface treatment apparatus illustrated in FIG. 1. The feed rate was 5 kg/h. The hot air temperature C was 220° C., and the hot air flow rate was 6 m³/min. The cool air temperature E was 5° C., the cool air flow rate was 4 m³/min, and the absolute moisture content of the cool air was 3 g/m³. The volume of air of the blower was 20 m³/min. The injection air flow rate was 1 m³/min. The heat-treated toner base particles had an average circularity of 0.965 and a weight-average particle diameter (D4) of 6.8 μm.

100 parts by mass of the heat-treated toner base particles were mixed with 0.8 parts by mass of silica fine particles having a BET specific surface area of 80 m²/g in a Henschel mixer (FM-75, manufactured by Mitsui Mining Co., Ltd.) at a rotational speed of 30 s⁻¹ for 10 minutes, thus yielding a toner 1. Table 1 lists the physical properties of the toner.

### Production Examples of Toners 2, 3, 5, and 7 and Comparative Toner 2

Toners 2, 3, 5, and 7 and a comparative toner 2 were produced in the same manner as in the production example of the toner 1, except that the pulverization/classification conditions and the treatment temperature of the surface treatment apparatus were adjusted so as to achieve the average particle size and average circularity listed in Table 1, and the additive amount of silica fine particles was changed as listed in Table 1. Table 1 lists the physical properties of these toners.

### Production Example of Toner 4

Binder resin 1 50.0 parts by mass
Binder resin 2 50.0 parts by mass
Fischer-Tropsch wax (peak temperature of maximum endothermic peak: 78° C.) 5.0 parts by mass
C.I. Pigment Blue 15:3 5.0 parts by mass
Aluminum 3,5-di-t-butyl salicylate compound 0.5 parts by mass
Polymer A 6.0 parts by mass

The materials were mixed in a Henschel mixer (FM-75, manufactured by Mitsui Mining Co., Ltd.) at a rotational speed of 20 s⁻¹ for 5 minutes. The materials were then mixed in a twin-screw kneader (PCM-30, manufactured by Ikegai Corporation) at 125° C. The mixture was cooled and was roughly crushed to 1 mm or less using a hammer mill. The roughly crushed mixture was pulverized using a mechanical grinder (T-250, manufactured by Freund-Turbo Corporation). Classification using a centrifugal force classifier (200TSP, manufactured by Hosokawa Micron Corporation) yielded toner base particles. The number of rotation of rotors in the centrifugal force classifier (200TSP, manufactured by Hosokawa Micron Corporation) was 50.0 s⁻¹.

The toner base particles had an average circularity of 0.955 and a weight-average particle diameter (D4) of 6.8 μm.

100 parts by mass of the toner base particles were mixed with 0.8 parts by mass of silica fine particles having a BET specific surface area of 80 m²/g in a Henschel mixer (FM-75, manufactured by Mitsui Mining Co., Ltd.) at a rotational speed of 30 s⁻¹ for 10 minutes, thus yielding a toner 4. Table 1 lists the physical properties of the toner.

### Production Examples of Toners 6, 8, 9, and 10 and Comparative Toner 1

Toners 6, 8, 9, and 10 and a comparative toner 1 were produced in the same manner as in the production example of the toner 4, except that the pulverization/classification conditions were adjusted so as to achieve the average particle size and average circularity listed in Table 1, and the additive amount of silica fine particles was changed as listed in Table 1. Table 1 lists the physical properties of the toners.

### Production Example 1 of Magnetic Carrier

Water was added to 100 parts by mass of Fe₂O₃, and Fe₂O₃ was pulverized in a ball mill for 15 minutes, thereby producing a magnetic core having an average particle size of 55 μm.

A liquid mixture of 1 part by mass of silicone resin (straight silicone resin) (KR271, manufactured by Shin-Etsu Chemical Co., Ltd.), 0.5 parts by mass of y-aminopropyltriethoxysilane, and 98.5 parts by mass of toluene was added to 100 parts by mass of the magnetic core. The solvent was removed by vacuum drying in a solution vacuum kneader at 70° C. for 5 hours while stirring. A magnetic carrier was produced by baking at 140° C. for 2 hours and sieving with a sieve shaker (300MM-2, manufactured by Tsutsui Scientific Instruments Co., Ltd.: 75 μm opening).

### Production Example of Developer 1

The toner 1 and the magnetic carrier were mixed at a mass ratio of 9.0:1.0 in a V-type blender (V-10: manufactured by Tokuju Corporation) at a rotational speed of 0.5 s⁻¹ for 5 minutes, thus yielding a developer 1. Table 2 lists the physical properties of the developer 1.

### Production Examples of Developers 2 to 17 and Production Examples of Comparative Developers 1 and 2

Developers 2 to 17 and comparative developers 1 and 2 were produced in the same manner as in the production example of the developer 1 except that the type of toner and the toner/carrier ratio were changed as listed in Table 2. Table 2 lists the physical properties of the developers.

TABLE 1

| | | Weight- | | Amount of silica |
|---|---|---|---|---|
| | | average | | fine particles per |
| | Temperature | particle | | 100 parts by mass of |
| | of | diameter | Average | toner base particles |
| Toner | hot air (° C.) | (μm) | circularity | (parts by mass) |
| Toner 1 | 220 | 6.8 | 0.965 | 0.8 |
| Toner 2 | 200 | 6.8 | 0.960 | 0.8 |
| Toner 3 | 230 | 6.8 | 0.970 | 0.8 |
| Toner 4 | — | 6.8 | 0.955 | 0.8 |
| Toner 5 | 245 | 6.8 | 0.975 | 0.8 |
| Toner 6 | — | 7.8 | 0.950 | 0.8 |
| Toner 7 | 260 | 6.2 | 0.980 | 0.8 |
| Toner 8 | — | 6.2 | 0.950 | 0.8 |
| Toner 9 | — | 5.5 | 0.950 | 0.4 |
| Toner 10 | — | 6.2 | 0.950 | 2.5 |
| Comparative | — | 9.5 | 0.940 | 5.0 |
| toner 1 | | | | |
| Comparative | 260 | 5.0 | 0.980 | 0.2 |
| toner 2 | | | | |

TABLE 2

| | | Amount | | |
|---|---|---|---|---|
| | | of toner | Developer | |
| | | per part by | Compressibility | Tap |
| | | mass of carrier | Ct | density |
| | Toner | (parts by mass) | (%) | (g/cm³) |
| Developer 1 | 1 | 9.0 | 37.2 | 0.80 |
| Developer 2 | 2 | 19.0 | 38.5 | 0.78 |
| Developer 3 | 3 | 5.7 | 36.2 | 0.82 |
| Developer 4 | 2 | 30.0 | 38.4 | 0.76 |
| Developer 5 | 3 | 4.0 | 35.4 | 0.84 |
| Developer 6 | 2 | 50.0 | 38.2 | 0.75 |
| Developer 7 | 3 | 22.0 | 33.5 | 0.87 |
| Developer 8 | 4 | 50.0 | 35.4 | 0.73 |
| Developer 9 | 5 | 50.0 | 40.2 | 0.78 |
| Developer 10 | 6 | 50.0 | 33.2 | 0.70 |
| Developer 11 | 7 | 50.0 | 32.1 | 0.80 |
| Developer 12 | 8 | 50.0 | 31.8 | 0.62 |
| Developer 13 | 7 | 2.6 | 41.8 | 0.90 |
| Developer 14 | 9 | 50.0 | 32.1 | 0.58 |
| Developer 15 | 8 | 2.3 | 43.5 | 0.93 |
| Developer 16 | 9 | 50.0 | 30.2 | 0.58 |
| Developer 17 | 10 | 50.0 | 45.4 | 0.58 |
| Comparative | Comparative | 50.0 | 50.3 | 0.55 |
| developer 1 | 1 | | | |
| Comparative | Comparative | 50.0 | 24.8 | 0.52 |
| developer 2 | 2 | | | |

### Example 1

### Dischargeability of the Developer 1 from a Developer Supply Cartridge was Evaluated in a Dischargeability Test by the Following Method

### (Evaluation 1) Dischargeability Test in Compressed State

A developer supply unit of a full-color copying machine image RUNNER ADVANCE C2030 (trade name) manufactured by CANON KABUSHIKI KAISHA was modified as the developer supply apparatus such that the developer supply container A (developer supply cartridge) illustrated in FIGS. 6A to 6C could be installed. The developer supply container A had a cam groove pattern illustrated in FIG. 8B. The pump stroke was 6.0 mm, and the discharging port had a diameter of 3.0 mm.

The developer supply container A was charged with 270 g of the developer 1. The developer 1 was compressed by vertically tapping the developer supply container A 1000 times at an amplitude of 10 cm with the discharge section facing downward.

The developer supply cartridge was then mounted in the developer supply apparatus. The number of rotation of the developer supply container was 0.85 s⁻¹. The developer discharge amount was measured every 1 second. The average discharge amount and the standard deviation of the discharge amounts measured every 1 second were calculated. Table 3 shows the results.
Evaluation criteria: Standard deviation of developer discharge amounts measured every 1 second
   A: 0.020 or less
   B: 0.021 or more and 0.030 or less
   C: 0.031 or more and 0.040 or less
   D: 0.041 or more

### (Evaluation 2) Dischargeability Test in Different Environments

The dischargeability of 135 g of the developer was evaluated at 45° C./95% RH using the developer supply cartridge. Dischargeability at 12.5° C./5% RH was then evaluated in the same manner. The average discharge amount and standard deviation were calculated. Table 3 shows the results.
Evaluation criteria: Standard deviation of developer discharge amounts measured every 1 second
   A: 0.020 or less
   B: 0.021 or more and 0.030 or less
   C: 0.031 or more and 0.040 or less
   D: 0.041 or more

### Examples 2 to 17 and Comparative Examples 1 and 2

The developers 2 to 17 and the comparative developers 1 and 2 were evaluated in the same manner as in Example 1. Table 3 shows the results.

### Comparative Example 3

The developer 15 was evaluated in the same manner as in Example 1 using a developer supply container and a supply apparatus for a full-color copying machine image RUNNER ADVANCE C2030 (trade name) manufactured by CANON KABUSHIKI KAISHA. Table 3 shows the results.

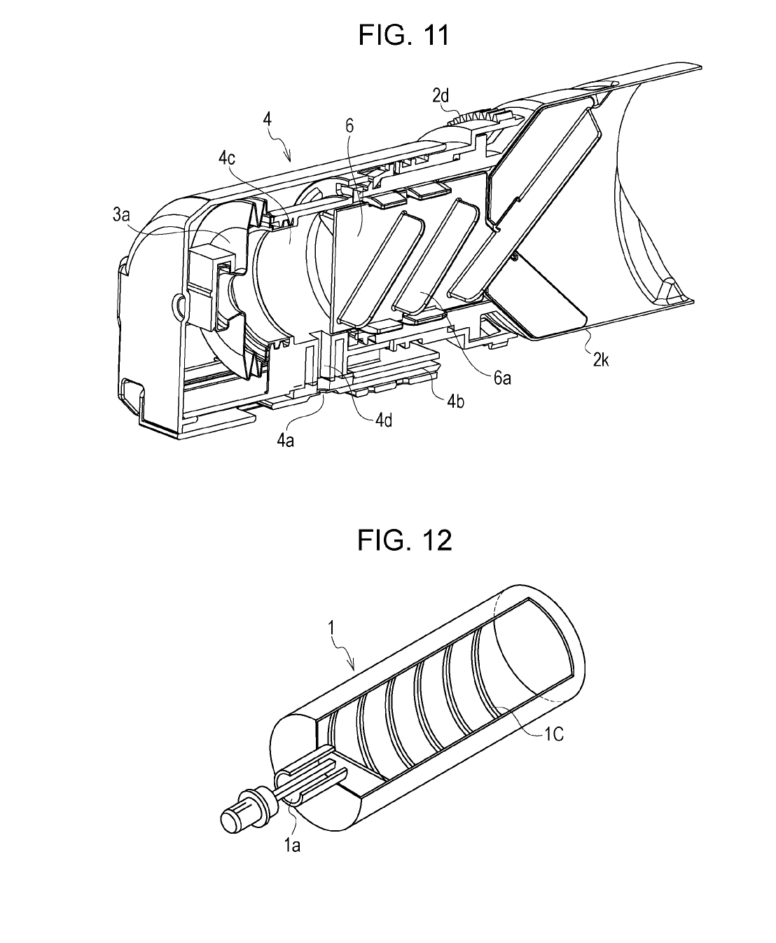

FIG. 12 is a schematic view of another existing developer supply container.

A developer supply container for a full-color copying machine image RUNNER ADVANCE C2030 (trade name) manufactured by CANON KABUSHIKI KAISHA is generally cylindrical like a developer supply container 1 illustrated in FIG. 12. The developer supply container is horizontally placed in the main body of the image-forming apparatus. The developer supply container is configured to rotate upon receiving the rotation drive from the main body of the image-forming apparatus. The developer supply container 1 has a spiral protrusion 1C on the inner surface thereof. As the developer supply container 1 rotates, a developer is conveyed in the axial direction along the spiral protrusion 1C and is discharged through an opening portion 1a in an end surface of the developer supply container 1.

TABLE 3

| | Dischargeability Test in | | | Dischargeability Test in Different Environments | | | | | |
|---|---|---|---|---|---|---|---|---|---|
| | Compressed State | | | 45° C./95% RH | | | 12.5° C./5% RH | | |
| | Average | Discharge | | Average | Discharge | | Average | Discharge | |
| | discharge | amount | | discharge | amount | | discharge | amount | |
| | amount | (standard | | amount | (standard | | amount | (standard | |
| | (g/s) | deviation) | Rating | (g/s) | deviation) | Rating | (g/s) | deviation) | Rating |
| Example 1 | 0.24 | 0.012 | A | 0.20 | 0.008 | A | 0.28 | 0.014 | A |
| Example 2 | 0.23 | 0.014 | A | 0.21 | 0.010 | A | 0.27 | 0.016 | A |
| Example 3 | 0.26 | 0.021 | B | 0.22 | 0.011 | A | 0.29 | 0.015 | A |
| Example 4 | 0.23 | 0.015 | A | 0.23 | 0.016 | A | 0.32 | 0.021 | B |
| Example 5 | 0.28 | 0.016 | A | 0.22 | 0.022 | B | 0.31 | 0.018 | A |
| Example 6 | 0.22 | 0.021 | B | 0.23 | 0.023 | B | 0.30 | 0.017 | A |
| Example 7 | 0.30 | 0.018 | A | 0.21 | 0.026 | B | 0.34 | 0.016 | A |
| Example 8 | 0.21 | 0.020 | B | 0.23 | 0.025 | B | 0.32 | 0.018 | A |
| Example 9 | 0.21 | 0.018 | A | 0.22 | 0.023 | B | 0.31 | 0.024 | B |
| Example 10 | 0.22 | 0.022 | B | 0.23 | 0.018 | A | 0.34 | 0.018 | A |
| Example 11 | 0.26 | 0.019 | A | 0.22 | 0.026 | B | 0.33 | 0.017 | A |
| Example 12 | 0.22 | 0.024 | B | 0.21 | 0.026 | B | 0.34 | 0.023 | B |
| Example 13 | 0.22 | 0.025 | B | 0.20 | 0.024 | B | 0.32 | 0.022 | B |
| Example 14 | 0.23 | 0.027 | B | 0.21 | 0.035 | C | 0.33 | 0.018 | A |
| Example 15 | 0.23 | 0.032 | C | 0.20 | 0.034 | C | 0.34 | 0.026 | B |
| Example 16 | 0.23 | 0.031 | C | 0.19 | 0.032 | C | 0.35 | 0.028 | B |
| Example 17 | 0.23 | 0.032 | C | 0.18 | 0.033 | C | 0.33 | 0.027 | B |
| Comparative | 0.24 | 0.033 | C | 0.21 | 0.036 | C | 0.32 | 0.035 | C |
| example 1 | | | | | | | | | |
| Comparative | 0.25 | 0.034 | C | 0.16 | 0.038 | C | 0.31 | 0.034 | C |
| example 2 | | | | | | | | | |
| Comparative | 0.32 | 0.038 | C | 0.24 | 0.040 | C | 0.38 | 0.040 | C |
| example 3 | | | | | | | | | |

While aspects of the present invention have been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-199425 filed Sep. 29, 2014 and No. 2015-173276 filed Sep. 2, 2015, which are hereby incorporated by reference herein in their entirety.

What is claimed is:

1. A developer supply cartridge detachably attachable to a developer supply apparatus comprising:
a developer supply container, the developer supply container comprising:
(i) a developer accommodation section configured to contain a developer;
(ii) a developer in the developer accommodation section;
(iii) a discharging port through which the developer in the developer accommodation section is discharged toward the developer supply apparatus;
(iv) a pump unit configured to perform an exhaust operation through the discharging port;
(v) a developer storage section configured to store a certain amount of developer before discharge, the developer storage section communicating with the developer accommodation section and being in contact with the discharging port; and
(vi) a suppression part configured to control inflow and suppression of inflow of the developer from the developer accommodation section to the developer storage section and suppress the inflow of the developer during the exhaust operation of the pump unit,
wherein the developer has a compressibility Ct of 30.0% or more and 45.0% or less.

2. The developer supply cartridge according to claim 1, wherein the developer has a tap density ρₜ of 0.60 g/cm³ or more and 0.90 g/cm³ or less.

3. The developer supply cartridge according to claim 1, wherein the developer is a two-component developer containing a carrier and a toner.

4. The developer supply cartridge according to claim 3, wherein the developer contains 3.0 parts or more and 30.0 parts or less by mass of the toner per part by mass of the carrier.

5. The developer supply cartridge according to claim 3, wherein the toner has an average circularity of 0.955 or more and 0.980 or less.

6. The developer supply cartridge according to claim 3, wherein
the toner contains toner base particles and an external additive, and
the amount of the external additive is 0.1 parts or more and 5.0 parts or less by mass per 100 parts by mass of the toner base particles.

7. The developer supply cartridge according to claim 6, wherein the external additive is silica fine particles.

8. The developer supply cartridge according to claim 1, wherein intake operation of the pump unit fluidizes the developer stored in the developer storage section.
